(19) United States
(12) Patent Application Publication
(10) Pub. No.: US 2023/0044760 A1
(43) Pub. Date: Feb. 9, 2023

(54) SYSTEMS AND METHODS FOR RECOMMENDING TRANSPORTATION SERVICES

(71) Applicant: BEIJING DIDI INFINITY TECHNOLOGY AND DEVELOPMENT CO., LTD., Beijing (CN)

(72) Inventor: Lingyu ZHANG, Beijing (CN)

(73) Assignee: BEIJING DIDI INFINITY TECHNOLOGY AND DEVELOPMENT CO., LTD., Beijing (CN)

(21) Appl. No.: 17/936,352

(22) Filed: Sep. 28, 2022

Related U.S. Application Data
(62) Division of application No. 16/729,281, filed on Dec. 27, 2019.
Application No. 16/729,281 is a continuation of application No. PCT/CN2019/074723, filed on Feb. 3, 2019.

(30) Foreign Application Priority Data
Feb. 6, 2018 (CN) 201810117329.4
Feb. 6, 2018 (CN) 201810117330.7
Feb. 6, 2018 (CN) 201810118481.4

(51) Int. Cl. G06Q 50/14; G06F 16/9535; G06F 16/9537; G06Q 10/04; G06Q 10/06; G06Q 30/06

(52) U.S. Cl. CPC G06Q 50/14; G06F 16/9535; G06F 16/9537; G06Q 10/04; G06Q 10/067; G06Q 30/0631

(57) ABSTRACT

The present disclosure relates to a system and method for recommending a service type to a user. The method comprises obtaining and storing in the device a plurality of previous service requests placed by the user, wherein each of the plurality of previous service requests comprises order information including the type of requested service and at least one of a service time or a service location. The method also comprises using the processor to generate a service type prediction model based on the order information of the plurality of previous service requests. The method further comprises receiving a service request including at least one of a currently service time or a currently service location from the user and using the service type prediction model to predict the user's preferred service type.

### CROSS-REFERENCE TO RELATED APPLICATIONS

This application is a divisional application of U.S. patent application Ser. No. 16/729,281, filed on Dec. 27, 2019, which is a continuation of International Application No. PCT/CN2019/074723, filed on Feb. 3, 2019, which claims priority to Chinese Patent Application No. 201810118481.4, filed on Feb. 6, 2018, Chinese Patent Application No. 201810117330.7, filed on Feb. 6, 2018, and Chinese Patent Application No. 201810117329.4, filed on Feb. 6, 2018, the contents of which are incorporated herein by reference in their entirety.

### TECHNICAL FIELD

The present disclosure generally relates to on-line services, and more particularly, relates to systems and methods for recommending a transportation type in an on-line service.

### BACKGROUND

In one aspect, with the development of Internet technology, the use of intelligent terminals for online car-hailing has become more and more popular. According to a service type that a user requests, a service platform provides a corresponding user interface for the requested service type, such that a user can place an order in the corresponding user interface.

In the prior art, in order to enable a user to request a service quickly, the service platform may predict a service type that the user requires at the moment, and switch from a current user interface to a user interface corresponding to the requested service to reduce the time spent on selecting a required user interface among user interfaces in an application manually.

However, the service type is generally predicted based on service types of the user's previous orders. In practical applications, the accuracy of such a prediction not high enough. Since the prediction is not accurate, the user always needs to select a required user interface manually, and the time consumed on placing an order will increase.

In another aspect, taking the e-commerce technology that provides transportation services as an example, the existing transportation platform may provide a user with diverse travel options, and the user may reserve a vehicle, for example, taxis, private cars (e.g., express car, chauffeured car, hitchhiking car), bicycles, etc., in advance before he/she travels, and information of the reserved vehicle such as the departure time of a bus, a train, etc., may be transmitted to the user. However, if more choices are provided for the transportation services, it should be considered that which transportation service the user may prefer, or which transportation service may improve the efficiency. Taking an actual scene that a user requests a service as an example, at evening peak hours, the user may select an express car service that he/she needs to wait for a long time since no driver providing express car service accepts the order. If the user attempts to call a taxi, and it may occur that no taxi driver accepts the order after a long time (for example, 2 minutes) either. Then user may have to request a chauffeured car. The three transportation services have different prices. The price of the express car service is lower than the taxi service, and the price of the taxi service is lower than the chauffeur car service. However, in this case, many users are willing to pay more money for the chauffeur car service instead of waiting for a longer time.

However, in the prior art, since a user cannot know which kind of transportation service he/she should choose so as to have a driver to accept the order before he/she tries each transportation service, the situation above occurs, which consumes more time.

In a further aspect, in actual scenarios, a user often needs to transfer among vehicles of different types in a travelling itinerary. For example, when a user starts his/her journey from A (short for location A) to B (short for location B), the user may need to ride a bicycle from A to a subway station nearby, and take the subway to the another subway station close to B, then take an express car or a taxi to B. Of course, there are other transportation modes from A to B. For example, the user may take an express car from A to a bus stop nearby, and take the bus to another bus stop close to B, then ride a bicycle to B.

It can be seen that with the increase of transit depots and transportation modes, the complexity for planning a journey is increased, more energy and time is consumed to think about how to arrive at another transit depot, and which transportation mode should be taken, resulting in a low efficiency. Thus, it is desirable for a system and a method for improving the efficiency and saving time in a journey.

### SUMMARY

According to an aspect of the present disclosure, a method for recommending a service type to a user is provided. The method may comprise obtaining and storing in the device a plurality of previous service requests placed by the user, wherein each of the plurality of previous service requests comprises order information including the type of requested service and at least one of a service time or a service location; using the processor to generate a service type prediction model based on the order information of the plurality of previous service requests; receiving a service request including at least one of a currently service time or a currently service location from the user; and using the service type prediction model to predict the user's preferred service type.

According to another aspect of the present disclosure, a system for recommending a service type to a user is provided. The system may include at least one storage medium including a set of instructions; and at least one processor configured to communicate with the at least one storage medium, wherein when executing the set of instructions, the at least one processor is directed to obtain and store in the device a plurality of previous service requests placed by the user, wherein each of the plurality of previous service requests comprises order information including the type of requested service and at least one of a service time or a service location; use the processor to generate a service type prediction model based on the order information of the plurality of previous service requests; receive a service request including at least one of a currently service time or a currently service location from the user; and use the service type prediction model to predict the user's preferred service type.

According to a further aspect of the present disclosure, a non-transitory computer readable medium is provided. The non-transitory computer readable medium comprises at least one set of instructions for recommending a service type to a user, wherein when executed by at least one processor of a computing device, the at least one set of instructions causes the computing device to perform a method. The method comprises obtaining and storing in the device a plurality of previous service requests placed by the user, wherein each of the plurality of previous service requests comprises order information including the type of requested service and at least one of a service time or a service location; using the processor to generate a service type prediction model based on the order information of the plurality of previous service requests; receiving a service request including at least one of a currently service time or a currently service location from the user; and using the service type prediction model to predict the user's preferred service type.

In some embodiments, the preferred service type has its own user interface, and the method further comprises providing the preferred service type user interface to the user.

In some embodiments, the service location includes a specific location or a statistical geographic area including the specific location.

In some embodiments, the service time includes a specific time point or a targeted statistical time period including the specific time point.

In some embodiments, the service type prediction model is based on Markov model, Gaussian model, mixed Gaussian model, Bayesian model, or a combination thereof.

In some embodiments, the service type prediction model is generated by performing clustering analysis on the types of the services requested on the basis of corresponding at least one of the service time or the service location to obtain a mixed Gaussian model for each service type, and determining, according to the mixed Gaussian model, a probability density value for each type of service, wherein the user's preferred service type is predicted based on the probability density values.

In some embodiments, the user's preferred service type is predicted by using a Bayesian model and the probability density value to determine a first probability value for each type of service; and designating the type of service that has the highest first probability value as the user's preferred service type.

In some embodiments, the designating step comprises determining the type of service that has the highest first probability value and if the highest first probability value is larger than or equal to a first preset threshold; and if it is, designating and recommending the type of service that has the highest first probability value as the user's preferred service type.

In some embodiments, before implementing the service type prediction model generation step, further comprises determining the frequency of each service type based on the order information of the plurality of previous service requests placed by the user to generate a Markov model; obtaining a second probability value for each service type by inputting the immediate previous service type requested by the user into the Markov model; determining the service type that has the highest second probability value and if the highest second probability value is larger than or equal to a second preset threshold; and if it is, designating and recommending the service type that has the highest second probability value as the user's preferred service type, or if it is not, performing the service type prediction model generation steps.

According to an aspect of the present disclosure, a method for estimating order-success rates of different transportation services for a user requesting a transportation service from a physical location at a service request time is provided. The method may comprises upon sensing an initiation of a transportation user interface (the interface) by the user, providing at least two transportation services to the user on the interface; obtaining the physical location of the user; and estimating, at the physical location of the user, based on a pre-established evaluation criteria, an order-success rate for each of the at least two transportation services.

According to another aspect of the present disclosure, a system for estimating order-success rates of different transportation services for a user requesting a transportation service from a physical location at a service request time is provided. The system may include at least one storage medium including a set of instructions; and at least one processor configured to communicate with the at least one storage medium, wherein when executing the set of instructions, the at least one processor is directed to upon sensing an initiation of a transportation user interface (the interface) by the user, provide at least two transportation services to the user on the interface; obtain the physical location of the user; and estimate, at the physical location of the user, based on a pre-established evaluation criteria, an order-success rate for each of the at least two transportation services.

According to a further aspect of the present disclosure, a non-transitory computer readable medium is provided. The non-transitory computer readable medium comprises at least one set of instructions for estimating order-success rates of different transportation services for a user requesting a transportation service from a physical location at a service request time, wherein when executed by at least one processor of a computing device, the at least one set of instructions causes the computing device to perform a method. The method may comprises upon sensing an initiation of a transportation user interface (the interface) by the user, providing at least two transportation services to the user on the interface; obtaining the physical location of the user; and estimating, at the physical location of the user, based on a pre-established evaluation criteria, an order-success rate for each of the at least two transportation services.

In some embodiments, the method further comprises transmitting the estimated order-success rates to match their respective transportation services on the interface.

In some embodiments, the pre-established evaluation criteria comprises a statistical time period evaluation criterion and a statistical geographic area evaluation criterion and the order-success rate estimating step comprises determining a targeted statistical time period where the time of the initiation of the interface falls under; determining a targeted statistical geographic area where the physical location of the user falls into; obtaining historical order-success rates of each of the transportation services during the targeted statistical time period inside the targeted statistical geographic area, by performing statistical analysis of a number of available transportation services and a total number of service requests placed during the targeted statistical time period inside the targeted statistical geographic area; and estimating the order-success rate for the each of the more than one type of transportation service based on the historical order-success rate.

In some embodiments, the pre-established evaluation criteria further comprises at least one of a weather condition and a traffic condition, the weather condition includes special weather conditions, and the traffic condition includes traffic congestion degree. The method further comprises if at the service time and the user physical location, at least one of a special weather condition or a certain traffic congestion degree exists, based on the nature of each transportation service, determining an influence factor imposed by the at least one of a special weather condition or a certain traffic congestion degree on each of the at least two transportation services, and estimating the order-success rate for each of the at least two transportation service at the user physical location based on its corresponding historical order-success rate and influence factor.

In some embodiments, the method further includes obtaining date of the service request and determining a targeted statistical date based on the date of the service request, and determining the historical order-success rate of a date that corresponds to the targeted statistical date.

In some embodiments, the method further comprises determining whether the estimated order-success rate for each of the two transportation services is smaller than a preset order-success rate threshold; and for those transportation services where the estimated order-success rate is smaller than the preset order-success rate threshold, obtaining a historical order-success rate for each of those transportation services during a time period that is immediately subsequent to the service request time (a postponed time period); and transmitting the historical order-success rates of those transportation services together with their corresponding postponed time periods to match their respective transportation services on the interface.

According to an aspect of the present disclosure, a method for recommending a transportation mode on a travel itinerary to a user is provided, wherein the travel itinerary comprises a plurality of segments, each having a segment route. The method may comprise obtaining and storing, in the storage medium, the user's previous travel data for each segment route that comprises departure location and time (departure data), arrival location and time (arrival data), and transportation mode used; retrieving and using, by the processor, the departure data and the arrival data of the segments to determine a correlation between each of the segment routes to generate personalized travel itineraries for the user that each includes one or more segment route; retrieving and using, by the processor, the transportation mode of each segment to determine, during each personalized travel itinerary, a usage frequency of each transportation mode during each segment route to establish a transportation mode estimating model; selecting a recommended travel itinerary comprising recommended segments from the personalized travel itineraries based on user's current location; and predicting transportation mode for each recommended segment using the transportation mode estimating model to generate recommended transportation mode for each recommended segment.

According to another aspect of the present disclosure, a system for recommending a transportation mode on a travel itinerary to a user is provided, wherein the travel itinerary comprises a plurality of segments, each having a segment route. The system may include at least one storage medium including a set of instructions; and at least one processor configured to communicate with the at least one storage medium, wherein when executing the set of instructions, the at least one processor is directed to obtain and store, in the storage medium, the user's previous travel data for each segment route that comprises departure location and time (departure data), arrival location and time (arrival data), and transportation mode used; retrieve and use, by the processor, the departure data and the arrival data of the segments to determine a correlation between each of the segment routes to generate personalized travel itineraries for the user that each includes one or more segment route; retrieve and use, by the processor, the transportation mode of each segment to determine, during each personalized travel itinerary, a usage frequency of each transportation mode during each segment route to establish a transportation mode estimating model; select a recommended travel itinerary comprising recommended segments from the personalized travel itineraries based on user's current location; and predict transportation mode for each recommended segment using the transportation mode estimating model to generate recommended transportation mode for each recommended segment.

According to a further aspect of the present disclosure, a non-transitory computer readable medium is provided. The non-transitory computer readable medium comprises at least one set of instructions for recommending a transportation mode on a travel itinerary to a user, wherein the travel itinerary comprises a plurality of segments, each having a segment route, wherein when executed by at least one processor of a computing device, the at least one set of instructions causes the computing device to perform a method. The method may comprise obtaining and storing, in the storage medium, the user's previous travel data for each segment route that comprises departure location and time (departure data), arrival location and time (arrival data), and transportation mode used; retrieving and using, by the processor, the departure data and the arrival data of the segments to determine a correlation between each of the segment routes to generate personalized travel itineraries for the user that each includes one or more segment route; retrieving and using, by the processor, the transportation mode of each segment to determine, during each personalized travel itinerary, a usage frequency of each transportation mode during each segment route to establish a transportation mode estimating model; selecting a recommended travel itinerary comprising recommended segments from the personalized travel itineraries based on user's current location; and predicting transportation mode for each recommended segment using the transportation mode estimating model to generate recommended transportation mode for each recommended segment.

In some embodiments, the method further comprises sending the recommended travel itinerary with its accompany recommended transportation mode for each recommended segment to the user.

In some embodiments, the personalized travel itinerary is generated by determining time gap between each two sequential segments Sᵢ and Sᵢ₊₁ based on the arrival time of Sᵢ and the departure time of Sᵢ₊₁; if the time gap is smaller than or equal to a first time gap threshold, generating a correlation between the two sequential segments; and connecting correlated segments to generate the personalized travel itinerary.

In some embodiments, the method further comprises if the time gap is larger than the first time gap threshold but smaller than or equal to a second time gap threshold, determining a distance gap between each two sequential segments Sᵢ and Sᵢ₊₁ based on the arrival location of Sᵢ and the departure location of Sᵢ₊₁; if the distance gap is smaller than or equal to a first distance gap threshold, generating a correlation between the two sequential segments; and connecting correlated segments to generate the personalized travel itinerary.

In some embodiments, the method further includes obtaining a road condition on each segment; and optimizing the transportation mode estimating model based on the road condition on each segment.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary transportation recommendation system according to some embodiments of the present disclosure;

FIG. 2 is a schematic diagram illustrating exemplary components of a computing apparatus according to some embodiments of the present disclosure;

FIG. 3 is a schematic diagram illustrating exemplary hardware and/or software components of an exemplary user terminal according to some embodiments of the present disclosure;

FIG. 4 is a flowchart illustrating an exemplary process for predicting a service type according to some embodiments of the present disclosure;

FIG. 5 is a flowchart illustrating a process 500 for predicting a service type according to some embodiments of the present disclosure;

FIGS. 6A and 6B are schematic diagrams of frequencies that a taxis service and an express car service is requested, respectively, according to some embodiments of present disclosure;

FIG. 7 is a flowchart illustrating a process 700 for predicting a service type according to some embodiments of the present disclosure;

FIG. 8 is a schematic diagram illustrating a service type prediction device according to some embodiments of the present disclosure;

FIG. 9 is a flowchart illustrating a process 900 for determining order-success rates of transportation services according to some embodiments of the present disclosure;

FIG. 10 is a flowchart illustrating a process 1000 for estimating order-success rates of transportation services according to some embodiments of the present disclosure;

FIG. 11A is a flowchart illustrating a process 1100 for estimating order-success rates of at least two transportation services according to some embodiments of the present disclosure;

FIG. 11B is a schematic diagram illustrating an user interface displaying the transportation services according to some embodiments of the present disclosure;

FIG. 11C is a schematic diagram illustrating an user interface displaying the transportation services according to some embodiments of the present disclosure;

FIG. 12 is a schematic diagram of an order-success rate estimation device according to some embodiments of the present disclosure;

FIG. 13 is a flowchart illustrating a process 1300 for recommending a transportation mode according to some embodiments of the present disclosure;

FIG. 14 is a flowchart illustrating a process 1400 for recommending a transportation mode according to some embodiments of the present disclosure; and

FIG. 15 is a schematic diagram of a transportation mode recommending device according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure, however, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flow charts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure be described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

Some embodiments of the present disclosure are directed to an on-line service prediction function applicable in, e.g., on-demand services, which is a newly emerged service or demand rooted only in the post-Internet era. It provides the technical solutions to customers that could rise only in the post-Internet era. In the pre-Internet era, it is impossible to predict types of services requested by users. Therefore, the present solution is deeply rooted in and aimed to solve a problem only occurred in the post-Internet era.

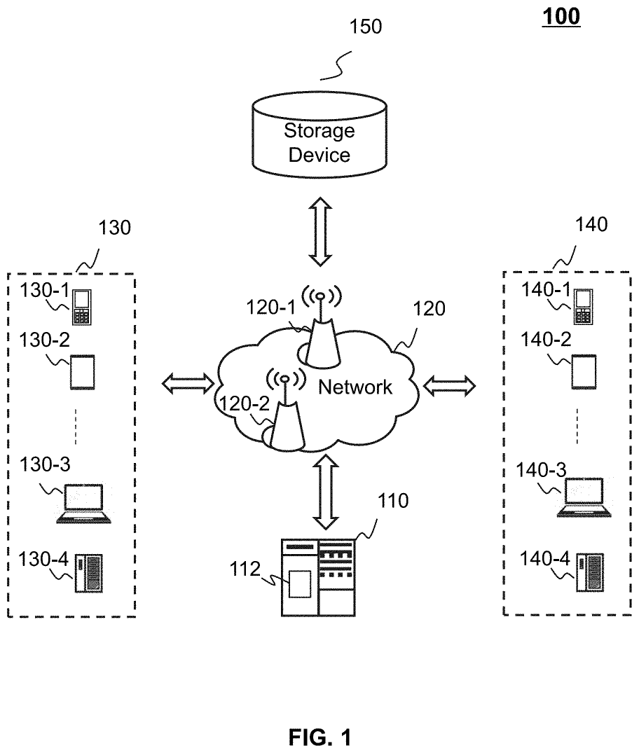

FIG. 1 illustrates an exemplary network environment of a transportation recommendation system according to some embodiments of the present disclosure. The transportation recommendation system 100 may be an online service platform for providing travelling related services. The transportation recommendation system 100 may include a server 110, a network 120, a user terminal 130, a driver device 140, and a storage device 150. In some embodiments, the transportation recommendation system 100 may further include a positioning device 160 (not shown in FIG. 1).

The transportation recommendation system 100 may be applicable in a plurality of services. Exemplary services may include a travel plan service, a navigation service, an on-demand service (e.g., a taxi hailing service, a chauffeur service, an express car service, a carpool service, a bus service, or a driver hire service), or the like, or a combination thereof.

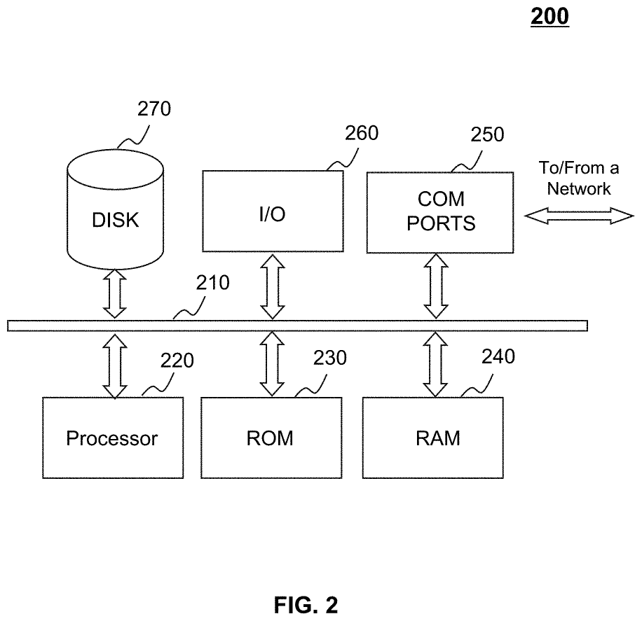

The server 110 may process data and/or information from one or more components of the transportation recommendation system 100 or an external data source (e.g., a cloud data center). The server 110 may communicate with the user terminal 130 and/or the driver device 140 to provide various functionality of online services. In some embodiments, the server 110 may be a single server, or a server group. The server group may be a centralized server group connected to the network 120 via an access point, or a distributed server group connected to the network 120 via one or more access points, respectively. In some embodiments, the server 110 may be locally connected to the network 120 or in remote connection with the network 120. For example, the server 110 may access information and/or data stored in the user terminal 130, the driver device 140, and/or the storage device 150 via the network 120. As another example, the storage device 150 may serve as backend data storage of the server 110. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented in a computing apparatus 200 having one or more components illustrated in FIG. 2 in the present disclosure.

In some embodiments, the server 110 may include a processing device 112. The processing device 112 may process information and/or data related to one or more functions described in the present disclosure. In some embodiments, the processing device 112 may perform main functions of the transportation recommendation system 100. For example, the processing device 112 may process information to predict a service type of a customer to improve the user experience of the platform as well as save time for requesting a service. In some embodiments, the processing device 112 may perform other functions related to the method and system described in the present disclosure.

In some embodiments, the processing device 112 may include one or more processing units (e.g., single-core processing device(s) or multi-core processing device(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the transportation recommendation system 100 (e.g., the server 110, the user terminal 130, the driver device 140, the storage device 150) may send information and/or data to other component(s) in the transportation recommendation system 100 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the transportation recommendation system 100 may be connected to the network 120 to exchange data and/or information.

The user terminal 130 and/or the driver device 140 may communicate with the server 110 via the network 120. In some embodiments, a passenger or a customer may be an owner of the user terminal 130. In some embodiments, the owner of the user terminal 130 may be someone other than the passenger or the customer. For example, an owner A of the user terminal 130 may use the user terminal 130 to send a service request for a passenger B, and/or receive a service confirmation and/or information or instructions from the server 110. In some embodiments, a driver may be a user of the driver device 140. In some embodiments, the user of the driver device 140 may be someone other than the driver. For example, a user C of the driver device 140 may use the driver device 140 to receive a service request for a driver D, and/or information or instructions from the server 110. In some embodiments, a driver may be assigned to use one of the driver device 140 for at least a certain period of time. For example, when a driver is available to provide an on-demand service, he/she may be assigned to use a driver terminal that receives an earliest request and a vehicle that is recommended to perform the type of on-demand service. In some embodiments, “passenger”, “customer”, “user” and “user terminal ” may be used interchangeably.

A customer may receive a service response for a trip via the user terminal 130. In some embodiments, the user terminal 130 may obtain information of the trip from the processing device 112 via the network 120. The user terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include a built-in computer, an onboard built-in television, a built-in tablet, etc. In some embodiments, the user terminal 130 may include a signal transmitter and a signal receiver configured to communicate with the positioning device 170 for locating the position of the passenger and/or the user terminal 130, and determining a relative distance from his/her position to a road.

The driver may receive a service request via the driver device 140. The driver device 140 may include a plurality of driver devices 140-1, 140-2, . . . , 140-n. In some embodiments, the driver device 140 may be similar to, or same as the user terminal 130. In some embodiments, the driver device 140 may be customized to implement online services based on travel related information obtained from the processing device 112.

The storage device 150 may store data and/or instructions. The data may include geographic location information, time information, driver information, customer information, external environment, or the like. Merely for illustration purposes, data related to geographic location information may include a service location (i.e., a departure location), an arrival location, a distance between the departure location and the arrival location, etc. Data related to time information may include a service time (i.e., a departure time), an order acceptance time, an order-complete time, etc. Data related to driver information may include a driver identification (ID), a user profile of the driver, an account of the driver, etc. Data related to driver information may include. In some embodiments, the storage device 150 may store data obtained from the user terminal 130 and/or the driver device 140. For example, the storage device 150 may store logs associated with the user terminal 130.

In some embodiments, the storage device 150 may store data and/or instructions that the processing device 112 may execute to predict service types of customers as described in the present disclosure. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, one or more components in the transportation recommendation system 100 may access the data or instructions stored in the storage device 150 via the network 120. In some embodiments, the storage device 150 may be directly connected to the server 110 as a backend storage.

The positioning device 160 may determine information associated with an object, for example, one or more of the user terminal 130, the driver device 140, etc. For example, the positioning device 160 may determine a physical location (geographic location) of the user terminal 130. In some embodiments, the positioning device 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information provided by the positioning device 160 may include a location, an elevation, a velocity, or an acceleration of the object, and/or a current time. The location may be in the form of coordinates, such as, a latitude coordinate and a longitude coordinate, etc. The positioning device 160 may include or associate with one or more satellites. The satellites may determine the information mentioned above independently or jointly. The positioning device 160 may send the information mentioned above to the user terminal 130, or the driver device 140 via the network 120.

One of ordinary skill in the art would understand that when an element of the transportation recommendation system 100 performs, the element may perform through electrical signals and/or electromagnetic signals. For example, when a user terminal 130 processes a task, such as placing an order of a trip from one place to another, the user terminal 130 may operate logical circuits in its processor to process such task. When the user terminal 130 sends out an instruction to the server 110, a processor of the user terminal 130 may generate electrical signals encoding the instruction. The processor of the user terminal 130 may then send the electrical signals to an output port. If the user terminal 130 communicates with the server 110 via a wired network, the output port may be physically connected to a cable, which further transmit the electrical signal to an input port of the server 110. If the user terminal 130 communicates with the server 110 via a wireless network, the output port of the user terminal 130 may be one or more antennas, which convert the electrical signals to electromagnetic signals. Similarly, a driver device 140 may process a task through operation of logical circuits in its processor, and receive an instruction and/or information from the server 110 via electrical signals or electromagnet signals. Within an electronic device, such as the user terminal 130, the driver device 140, and/or the server 110, when a processor thereof processes an instruction, sends out an instruction, and/or performs an action, the instruction and/or action is conducted via electrical signals. For example, when the processor retrieves data from a storage medium (e.g., the storage device 150), it may send out electrical signals to a read device of the storage medium, which may read structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary components of a computing apparatus according to some embodiments of the present disclosure. The server 110, the user terminal 130, and/or the driver device 140, the storage device 150 may be implemented on the computing apparatus 200 according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing apparatus 200 may be configured to implement any components that perform one or more functions disclosed in the present disclosure. For example, the computing apparatus 200 may implement any component of the transportation recommendation system 100 as described herein. In FIGS. 1-2, only one such computer device is shown purely for convenience purposes. One of ordinary skill in the art would understand at the time of filing of this application that the computer functions relating to the service as described herein may be implemented in a distributed fashion on a number of similar platforms, to distribute the processing load.

The computing apparatus 200, for example, may include COM ports 250 connected to and from a network connected thereto to facilitate data communications. The computing apparatus 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing apparatus may include the internal communication bus 210, program storage and data storage of different forms including, for example, a disk 270, and a read only memory (ROM) 230, or a random access memory (RAM) 240, for various data files to be processed and/or transmitted by the computing apparatus. The exemplary computing apparatus may also include program instructions stored in the ROM 230, RAM 240, and/or another type of non-transitory storage medium to be executed by the processor 220. The methods and/or processes of the present disclosure may be implemented as the program instructions. The computing apparatus 200 also includes an I/O component 260, supporting input/output between the computer and other components. The computing apparatus 200 may also receive programming and data via network communications.

Merely for illustration, only one processor and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing apparatus 200 executes both operation A and operation B, it should be understood that operation A and operation B may also be performed by two different CPUs and/or processors jointly or separately in the computing apparatus 200 (e.g., the first processor executes operation A and the second processor executes operation B, or the first and second processors jointly execute operations A and B).

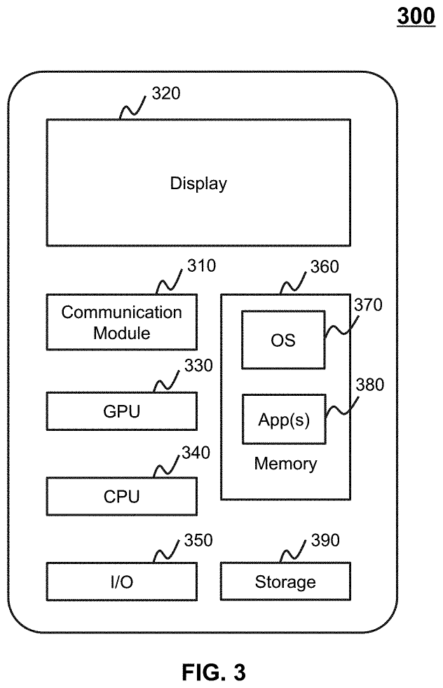

FIG. 3 is a block diagram illustrating exemplary hardware and/or software components of an exemplary requestor terminal according to some embodiments of the present disclosure. The information provider 130 or the communication platform 140 may be implemented on the mobile device 300 according to some embodiments of the present disclosure. As illustrated in FIG. 3, the mobile device 300 may include a communication module 310, a display 320, a graphic processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to a service request or other information from the transportation recommendation system on the mobile device 300. User interactions with the information stream may be achieved via the I/O devices 350 and provided to the processing device112 and/or other components of the transportation recommendation system 100 via the network 150.

In order to implement various modules, units and their functions described above, a computer hardware platform may be used as hardware platforms of one or more elements (e.g., a component of the server 110 described in FIG. 1). Since these hardware elements, operating systems, and program languages are common, it may be assumed that persons skilled in the art may be familiar with these techniques and they may be able to provide information required in the data classification according to the techniques described in the present disclosure. A computer with a user interface may be used as a personal computer (PC), or other types of workstations or terminal devices. After being properly programmed, a computer with a user interface may be used as a server. It may be considered that those skilled in the art may also be familiar with such structures, programs, or general operations of this type of computer device. Thus, additional explanations are not described for the figures.

In order to clarify objectives, technical solutions, and advantages of the disclosed embodiments, the technical solutions in the present disclosure will be described clearly and completely below in combination with the drawings in the present disclosure.

With the development of Internet technology, the use of intelligent terminals for online car-hailing has become more and more popular. Along with the continuous development of the car-hailing services, users have a variety of types of car-hailing services to choose from on the service platform, for example: taxi, express car, chauffeured car, carpooling, car rental, etc.

In the prior art, different types of services have different ordering interfaces due to differences in charging mechanism and the hailing mechanism of each service type. In order to enable the user to place an order or pay a bill faster, the service platform predicts a possible service type of the user and switches to an ordering interface corresponding to the predicted service type when the user logs in the service platform or triggers an ordering interface of the service platform.

However, the existing prediction of the user's current service type is determined based on the service type requested by the user in the previous orders. Taking that the user's previous order relates to an “Express car” service as an example, when the user initiates the service platform, the service platform will display an interface of “Express” automatically, which is inconsistent with an actual requirement of the user. That is, if the required service type of the user is not “Express”, the user needs to switch to another ordering interface, thus reducing the efficiency for requesting a service. Therefore, how to improve the accuracy of the prediction for a service type, such that the predicted service type is consistent with the actually required service type of the user, so as to improve the efficiency has become a technical problem to be solved.

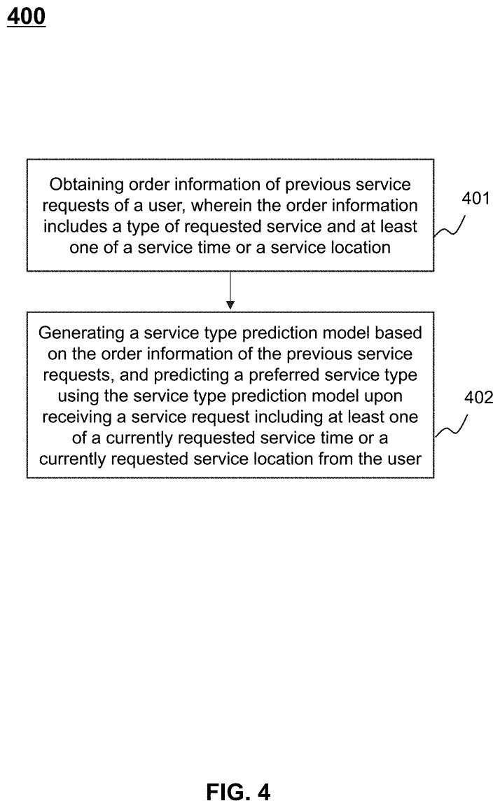

FIG. 4 is a flowchart illustrating a process 400 for predicting a service type according to some embodiments of the present disclosure. In some embodiments, the process 400 shown in FIG. 4 may be implemented in the transportation recommendation system 100 illustrated in FIG. 1. For example, at least a part of the process 400 may be stored in a storage device (e.g., the DISK 270 of the computing apparatus 200) as a form of instructions, and invoked and/or executed by the server 110 (e.g., the processor 220 of the computing apparatus 200). In some embodiments, a part of the process 400 may be implemented on a terminal device. The operations of the illustrated process 400 presented below are intended to be illustrative. In some embodiments, the process 400 may be accomplished with one or more additional operations not described, and/or without one or more of the operations discussed. Additionally, the order in which the operations of the process 400 as illustrated in FIG. 4 and described below is not intended to be limiting.

In 401, order information of previous service requests of a user may be obtained. The order information may include a type of the requested service and at least one of a service time or a service location. In some embodiments, the order information may be obtained by the processing device 112.

In 402, a service type prediction model may be generated based on the order information of the previous service requests, and a preferred service type may be predicted using the service type prediction model upon receiving a service request including at least one of a currently requested service time or a currently requested service location from the user. In some embodiments, the service type prediction model may be generated by the processing device 112.

It should be noted that the execution subject of the service type prediction method described in the present disclosure (e.g., the process 400) may specifically be a service type prediction device, and the service type prediction device may be implemented by hardware and/or software. Generally, the service type prediction device may be integrated into a cloud server in which the service platform is implemented, and be used together with a data server in which various databases is stored and the service platform is implemented. In addition, a server in which the prediction device is implemented may be the same as the data server, or another server of a same server cluster as the data server, which is not limited in the present disclosure.

The previous service requests refers to service requests placed by a user in a historical time period (e.g., yesterday, last week, last month, last three month, etc.). In some embodiments, the previous service requests of the user may relate to car-hailing services requested by the user through the service platform. The car-hailing service may be a real-time service or a reserved service. The car-hailing service may include but not limited to taxi service, express car service, chauffeur service, ride-sharing service, car rental service, carpooling service, etc.

In some embodiments, the order information of each of the previous service requests may include a type of the requested service, a service time and/or a service location. In some embodiments, the order information may also include an order number, a price, or the like. In some embodiments, the service time may include a specific time point or a targeted statistical time period including the specific time point. Merely by ways of example, the service time may specifically be a start time of the requested service, an end time of the requested service, a waiting time of the requested service, or the like, or a combination thereof. In some embodiments, the service location may include a specific location or a statistical geographic area including the specific location. Merely by ways of example, the service location may include a departure location of the requested service, an arrival location of the requested service, or the like, or a combination thereof.

Since the order information of the previous service requests includes various types of information, the analysis of the information may indicate the preference/behavior of the user on a service type (i.e., a probability that the user chooses a service type in some specific scenarios).

For example, most previous service requests of a user on workdays (i.e., Monday to Friday) are taxi service, and most previous service requests on Saturday and Sunday are express car service. By analyzing the preference/behavior of the user in view of service time, it may be concluded that the probability that the user chooses a taxi service on workdays is relatively high, and the probability that the user chooses an express car service on holidays is relatively high as well. As another example, most previous service requests with a service location being at or close to an office building are taxi services, and most previous service requests with a service location being at or close to a community are express car services.

By analyzing the preference/behavior of the user in view of service location, the office building may be the user's working place. When the user leaves his/her working place for a destination, the probability that the user chooses a taxi service is relatively high. And the community may be the user's home. When the user leaves his/her home for a destination, the probability that the user chooses an express car service is relatively high. The behavioral rules or preferences of the user may be comprehensively analyzed in view of the service time and/or the service location to obtain the probability that the user chooses a service type in a specific scenario.

Therefore, a mathematical model may represent the behavior/preference pattern of the user. In some embodiments, a service type prediction model may be constructed to predict the service type of a real time service request of the user. The service type prediction model may include but is not limited to a Markov model, a Gaussian model, a Mixed Gaussian model, a Bayesian model, etc. The service type prediction model may be used to identify a historical scenario being similar to the current scenario according to a currently requested service time and/or a currently requested service location of a user, and designate the service type under the historical scenario as a preferred service type of the user. As used herein, the currently requested service time refers to a service time of a current order, and the currently requested service location refers to a service location of a current order.

The method for predicting the service type provided in the process 400 of the present disclosure establishes a service type prediction model for a user according to the service time and/or service location in the order information of previous service requests of the user. The service type prediction model may be used to predict a preferred service type of a real time service request at a currently requested service time and/or a currently requested service location. Since the service type is predicted using the service type prediction model and the order information, the accuracy of the prediction is effectively improved compared with the methods in the prior art. Further, the service platform may display an ordering interface according to the predicted service type, such that the actual requirements of the user is meets, thus reducing the user's time and improving the efficiency when the user requests a service.

It should be noted that the above description is merely provided for the purposes of illustration, and not intended to limit the scope of the present disclosure. For persons having ordinary skills in the art, multiple variations and modifications may be made under the teachings of the present disclosure. For example, the processing device 112 may further transmit the preferred service type to an user interface of a terminal device of the user for display. However, those variations and modifications do not depart from the scope of the present disclosure.

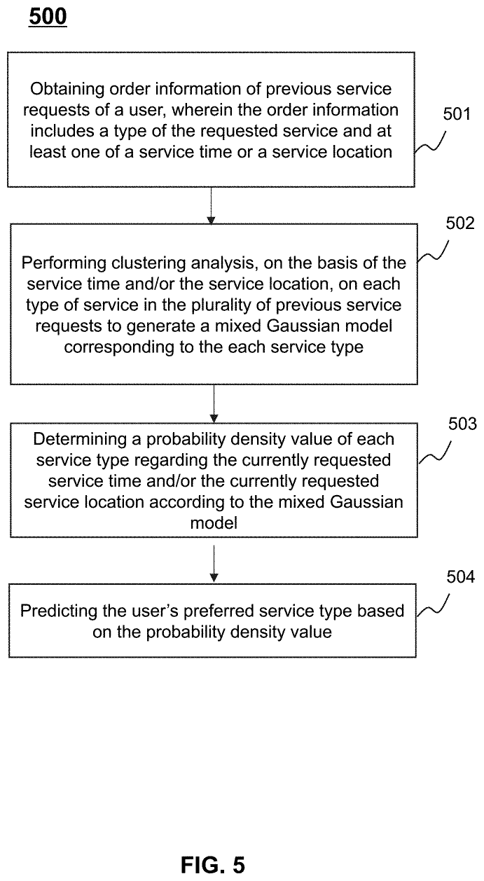

FIG. 5 is a flowchart illustrating a process 500 for predicting a service type according to some embodiments of the present disclosure. In some embodiments, operations described in the process 500 may be described in combination with the process 400.

In 501, order information of previous service requests of a user may be obtained. The order information may include a type of the requested service and at least one of a service time or a service location.

In 502, clustering analysis may be performed, on the basis of the service time and/or the service location, on each type of service in the plurality of previous service requests to generate a mixed Gaussian model corresponding to the each service type. In some embodiments, the clustering analysis may be performed by the processing device 112.

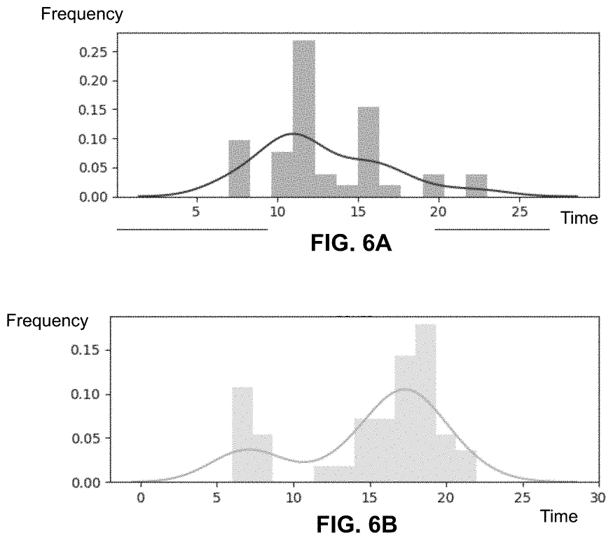

In 503, the processing device 112 may determine a probability density value of each service type regarding the currently requested service time and/or the currently requested service location according to the mixed Gaussian model. Detailed description regarding the probability density value of each service type may be disclosed elsewhere, for example, FIGS. 6A and 6B.

In 504, the user's preferred service type may be predicted based on the probability density value.

The embodiments provided in the process 500 may be similar to the embodiments in the process 400. In some embodiments, the previous service requests of the user may relate to car-hailing services requested by the user through the service platform in the historical time period. The car-hailing service may be a real-time service or a reserved service. The car-hailing service may include but not limited to taxi service, express car service, chauffeur service, ride-sharing service, car rental service, carpooling service, etc. In some embodiments, the order information of each of the previous service requests may include a type of the requested service, a service time and/or a service location. In some embodiments, the order information may also include an order number, a price, or the like. The service time may specifically be a start time of the requested service, an end time of the requested service, a waiting time of the requested service, or the like, or a combination thereof. The service location may include a departure location of the requested service, an arrival location of the requested service, or the like, or a combination thereof.

The embodiments described in the process 500 also provides a specific implementation for predicting a service type. In the process 500, each type of service in the plurality of previous service requests may be clustered according to the service time and/or the service location to generate a Mixed Gaussian model corresponding to the each service type. Merely for illustration purposes, the clustering of the service time is taken as an example.

It should be noted that the above description is merely provided for the purposes of illustration, and not intended to limit the scope of the present disclosure. For persons having ordinary skills in the art, multiple variations and modifications may be made under the teachings of the present disclosure. For example, the processing device 112 may further transmit the preferred service type to an user interface of a terminal device of the user for display. However, those variations and modifications do not depart from the scope of the present disclosure.

FIGS. 6A and 6B are schematic diagrams of frequencies that a taxis service and an express car service is requested, respectively, according to some embodiments of present disclosure. Table 1 is order information of previous service requests of a user. FIGS. 6A and 6B will be described in combination with Table 1. The order information in Table 1 may be processed to extract time points of the previous service requests. The extracted time points may fall into one or more time periods. Then, service types corresponding to each time period may be obtained and represented in a form of histogram as shown in FIGS. 6A and 6B. It may be concluded from the histogram that the peak of the taxi service is around 12 o'clock and the peaks of the express car service are around 7 o'clock and 18 o'clock. Therefore, in view of service time, a cluster center of the service time of the taxi service is 12 o'clock, and cluster centers of the service time of the express car service are 7 o'clock and 18 o'clock.

In some embodiments, the cluster centers may be used to determine Gaussian distributions. The Gaussian distributions may be centered on the cluster centers. For example, a Gaussian model for a taxi service may have a center of 12 o'clock. As another example, a Mixed Gaussian model for an express service, which is composed of two superimposed Gaussian distributions, have a first center of 7 o'clock and a second center of 18 o'clock.

TABLE 1

| Time | Service Type |
|---|---|
| 2017 Mar. 9 10:18 | Taxi |
| 2017 Mar. 9 15:34 | Express car |
| 2017 Mar. 9 16:38 | Taxi |
| 2017 Mar. 13 18:28 | Express car |
| 2017 Mar. 16 11:09 | Taxi |
| 2017 Mar. 16 17:48 | Express car |
| 2017 Mar. 16 19:39 | Taxi |
| 2017 Mar. 21 7:15 | Express car |
| 2017 Mar. 21 7:45 | Taxi |
| 2017 Mar. 21 8:46 | Express car |
| 2017 Mar. 22 18:46 | Express car |
| 2017 Mar. 24 11:16 | Taxi |
| 2017 Mar. 29 16:25 | Express car |
| 2017 Apr. 3 16:51 | Taxi |
| 2017 Apr. 5 6:57 | Express car |
| 2017 Apr. 6 11:23 | Taxi |
| 2017 Apr. 10 18:27 | Express car |
| 2017 Apr. 13 11:52 | Taxi |
| 2017 Apr. 18 18:14 | Express car |
| 2017 Apr. 21 11:14 | Taxi |
| 2017 Apr. 21 16:39 | Express car |
| 2017 Apr. 21 17:33 | Taxi |
| 2017 Apr. 22 8:52 | Express car |

The method for establishing a Mixed Gaussian model based on the service time can be realized in various ways. In some embodiments, a service time-based Mixed Gaussian model of each service type may be obtained by vectorizing the time points and calculating a mean value and a square deviation corresponding to each time point.

In the embodiment described above, the service time is taken into consideration to describe the prediction model. In some embodiments, the Mixed Gaussian model may be established according to the service location, or a combination of both the service time and the service location. The method described in the process 500 establishes the Mixed Gaussian model based on the time point of the service time. In some embodiments, the Mixed Gaussian model may be established according to other information associated with the service time, such as the date of the service time, whether the service time is on holiday, etc., and so does the service location.

A probability density value of each service type regarding the currently requested service time may be determined by incorporating the currently requested service time into the Mixed Gaussian model, and the probability density value may be used to predict the user's preferred service type.

By establishing the Mixed Gaussian model to predict a service type of that the user request in real time, the prediction accuracy is improved effectively, such that the service platform may use the predicted service type to display a corresponding user interface to the user, thereby improving the efficiency that the user requests a service.

In some embodiments, the predicting of the service type according to the probability density value of each service type in 504 of the process 500 may further include determining a first probability of each service type using a Bayesian model and the probability density value of each service type, and designating a service type corresponding to a largest probability value as the user's preferred service type (i.e., predicted service type).

The Bayesian model may be used to represent the probability of a service type under various dynamic conditions, which can be understood as a mathematical expression of the probability that the service type is selected. Therefore, the first probability of each service type may be obtained by processing the probability density value of each service type. The first probability may indicate the possibility that a service type will be selected at the currently requested service time and/or the currently requested service location. Therefore, it may be more accurate to designate a service type with a largest first probability value as the predicted service type will further improve the accuracy of the service type prediction.

In some embodiments, in order to make the prediction more close to a user's actual requirement, a service type with a largest first probability value may be designated as the predicted service type. During this process, a determination may be made as to whether the largest first probability is larger than or equal to a first preset threshold. If the largest first probability is larger than or equal to the first preset threshold, the service type may be designated as the predicted service type and be output to, for example, the user terminal 130.

Since order information of one user is different from that of other users, the service type prediction model may not be applicable to other users, especially for users having a small number of orders. Therefore, by setting the first preset threshold, a service type with the largest first probability value may be verified, and the user's preferred service type may be determined only when the probability value of the service type is larger than or equal to the first preset threshold.

If the probability value of the service type is not greater than or equal to the first preset threshold, other service type prediction models or existing methods may be used to predict a service type. In some embodiments, for the users having a small number of orders, once the order information of the users is sufficient to establish the service type prediction model, the transportation recommendation system 100 may predict service types for the users according to the service type prediction method described above.

The present disclosure provides a service type prediction method , which is used to predict, through the decomposition of order information of previous service requests combining with a Mixed Gaussian model, a service type that a user requests, the prediction process is effective, and the accuracy of the prediction is improved.

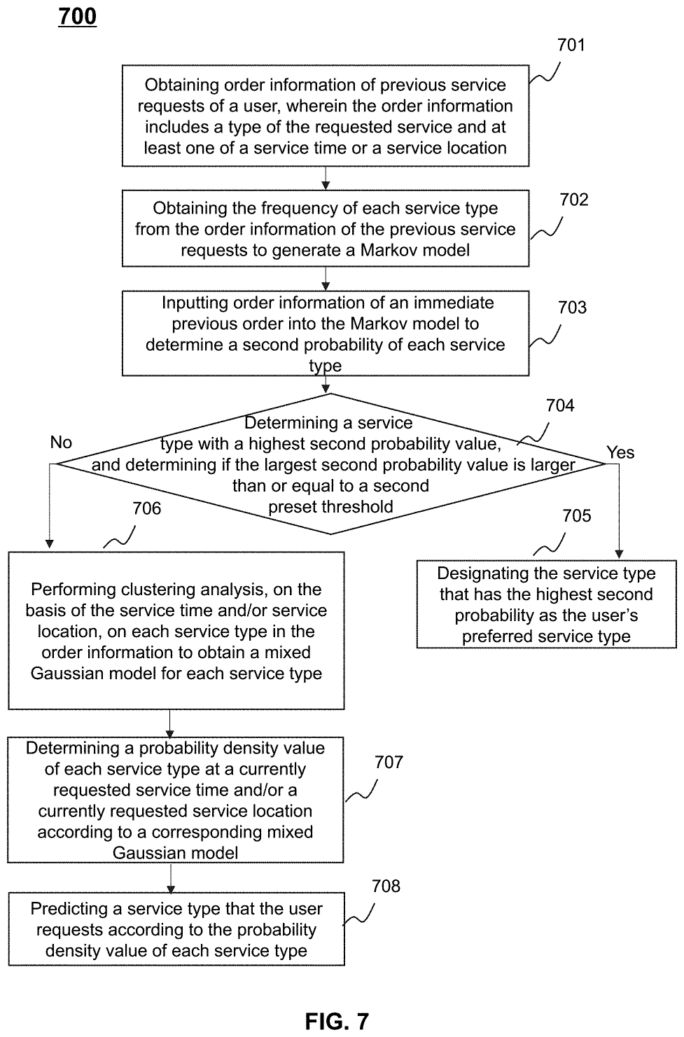

FIG. 7 is a flowchart illustrating a process 700 for predicting a service type according to some embodiments of the present disclosure. In some embodiments, the process 700 may be described in combination with the process 500.

In 701, order information of previous service requests of a user may be obtained. The order information may include a type of the requested service and at least one of a service time or a service location. In some embodiments, the order information may be obtained by the processing device 112.

In 702, the processing device 112 may obtain the frequency of each service type from the order information of the previous service requests to generate a Markov model.

In 703, the processing device 112 may input order information of an immediate previous order into the Markov model to determine a second probability of each service type. The immediate previous order may also be referred to as a latest historical order.

In 704, a service type with a largest second probability value may be determined, and a determination may be made as to whether the largest second probability value is larger than or equal to a second preset threshold.

If the largest second probability value is larger than or equal to the second preset threshold, the process may proceed to 705. If the largest second probability value is not greater than or equal to the second preset threshold, the process may proceed to 706.

In 705, the service type corresponding to the largest second probability may be designated as the user's preferred service type. The user's preferred service type may be output to, for example, the user terminal 130.

In 706, the processing device 112 may perform clustering analysis, on the basis of the service time and/or service location, on each service type in the order information to obtain a mixed Gaussian model for each service type.

In 707, the processing device 112 may determine a probability density value of each service type at a currently requested service time and/or a currently requested service location according to a corresponding mixed Gaussian model.

In 708, a service type that the user requests may be predicted according to the probability density value of each service type.

In order to improve the efficiency of the service type prediction, the processing device 112 may combine the Markov model and the Mixed Gaussian model to improve the prediction efficiency of the entire prediction process.

In some embodiments, the service type of the user requests may be predicted using the Markov model after previous service requests of the user are obtained.

Table 2 shows order information of previous service requests of a user. Table 3 shows statistical data of the order information of the previous service requests of Table 2.

TABLE 2

| Time | Service Type |
|---|---|
| 2017 May 30 18:36 | Taxi |
| 2017 Jun. 2 17:58 | Taxi |
| 2017 Jun. 12 12:04 | Taxi |
| 2017 Jun. 20 20:07 | Express car |
| 2017 Jun. 27 9:43 | Taxi |
| 2017 Jun. 28 13:06 | Taxi |
| 2017 Jun. 28 14:56 | Taxi |
| 2017 Jun. 28 17:40 | Taxi |
| 2017 Jun. 29 9:10 | Taxi |
| 2017 Jun. 29 11:16 | Taxi |
| 2017 Jun. 29 16:44 | Taxi |
| 2017 Jul. 3 10:26 | Taxi |
| 2017 Jul. 4 18:58 | Taxi |
| 2017 Jul. 4 22:18 | Taxi |
| 2017 Jul. 6 10:01 | Taxi |
| 2017 Jul. 7 15:06 | Taxi |
| 2017 Jul. 7 19:27 | Taxi |
| 2017 Jul. 11 9:30 | Taxi |
| 2017 Jul. 13 11:36 | Express car |
| 2017 Jul. 15 15:25 | Taxi |
| 2017 Jul. 17 9:00 | Taxi |
| 2017 Jul. 18 11:42 | Taxi |
| 2017 Jul. 18 20:58 | Taxi |

TABLE 3

Next Time

| Last Time | Taxi | Express car |
|---|---|---|
| Taxi | 18 | 2 |
| Express car | 2 | 0 |

In some embodiments, the service type of an immediate previous service request of the user may be obtained from the order information, and a skip matrix may be determined based on the service type of the immediate previous service and the statistical data in Table 3.

The second probability of each service type may be obtained. The probability that the user requests an express car service is 0, and the probability that the user requests a taxi service is 1. Then a service type corresponding to the largest second probability may be designated as the predicted service type once the probability value of the service type is larger than or equal to the second preset threshold. Otherwise, the service type prediction may be conducted using the Mixed Gaussian model as described above.

In some embodiments, the Markov model may be more effective for users who always requests a single service type. In comparison with the mixed Gaussian model, the computation load for the Markov model may be smaller, which is beneficial to improve the processing efficiency of a service prediction device being configured to predict service types of users. In the embodiment, the first/second preset threshold is set in accordance with actual requirements, such that when the Markov model is not suitable for processing the user's order information, the service type of the user may be predicted according to the Mixed Gaussian model effectively.

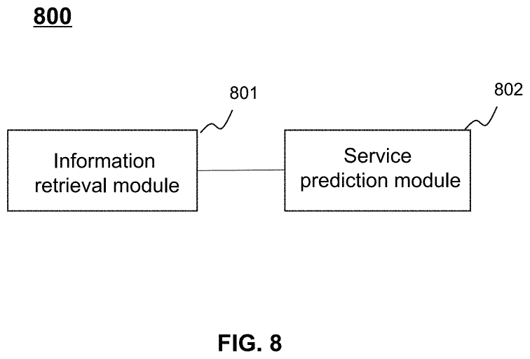

FIG. 8 is a schematic diagram illustrating a service type prediction device according to some embodiments of the present disclosure. The service type prediction device 800 may include an information retrieval module 801 and a service prediction module 802.

The information retrieval module 801 may be configured to obtain a plurality of previous service requests placed by the user, wherein each of the plurality of previous service requests comprises order information including the type of service requested and at least one of a service time or a service location.

The service prediction module 802 may be configured to generate a service type prediction model based on the order information of the plurality of previous service requests and upon receiving a service request including at least one of a currently service time or a currently service location from the user, use the service type prediction model to predict the user's preferred service type.

It should be noted that the execution subject of the service type prediction method described in the present disclosure (e.g., the process 400) may specifically be a service type prediction device, and the service type prediction device may be implemented by hardware and/or software. Generally, the service type prediction device may be integrated into a cloud server in which the service platform is implemented, and be used together with a data server in which various databases is stored and the service platform is implemented. In addition, a server in which the prediction device is implemented may be the same as the data server, or another server of a same server cluster as the data server, which is not limited in the present disclosure.

The previous service requests refers to service requests placed by a user in a historical time period (e.g., yesterday, last week, last month, last three month, etc.). In some embodiments, the previous service requests of the user may relate to car-hailing services requested by the user through the service platform. The car-hailing service may be a real-time service or a reserved service. The car-hailing service may include but not limited to taxi service, express car service, chauffeur service, ride-sharing service, car rental service, carpooling service, etc.

In some embodiments, the order information of each of the previous service requests may include a type of the requested service, a service time and/or a service location. In some embodiments, the order information may also include an order number, a price, or the like. In some embodiments, the service time may include a specific time point or a targeted statistical time period including the specific time point. Merely by ways of example, the service time may specifically be a start time of the requested service, an end time of the requested service, a waiting time of the requested service, or the like, or a combination thereof. In some embodiments, the service location may include a specific location or a statistical geographic area including the specific location. Merely by ways of example, the service location may include a departure location of the requested service, an arrival location of the requested service, or the like, or a combination thereof.

Since the order information of the previous service requests includes various types of information, the analysis of the information may indicate the preference/behavior of the user on a service type (i.e., a probability that the user chooses a service type in some specific scenarios).

For example, most previous service requests of a user on workdays (i.e., Monday to Friday) are taxi service, and most previous service requests on Saturday and Sunday are express car service. By analyzing the preference/behavior of the user in view of service time, it may be concluded that the probability that the user chooses a taxi service on workdays is relatively high, and the probability that the user chooses an express car service on holidays is relatively high as well. As another example, most previous service requests with a service location being at or close to an office building are taxi services, and most previous service requests with a service location being at or close to a community are express car services. By analyzing the preference/behavior of the user in view of service location, the office building may be the user's working place. When the user leaves his/her working place for a destination, the probability that the user chooses a taxi service is relatively high. And the community may be the user's home. When the user leaves his/her home for a destination, the probability that the user chooses an express car service is relatively high. The behavioral rules or preferences of the user may be comprehensively analyzed in view of the service time and/or the service location to obtain the probability that the user chooses a service type in a specific scenario.

Therefore, a mathematical model may represent the behavior/preference pattern of the user. In some embodiments, a service type prediction model may be constructed to predict the service type of a real time service request of the user. The service type prediction model may include but is not limited to a Markov model, a Gaussian model, a Mixed Gaussian model, a Bayesian model, etc. The service type prediction model may be used to identify a historical scenario being similar to the current scenario according to a currently requested service time and/or a currently requested service location of a user, and designate the service type under the historical scenario as a preferred service type of the user.

In some embodiments, the service prediction module 802 may be configured to perform clustering analysis, on the basis of the service time and/or the service location, on each type of service in the plurality of previous service requests to generate a mixed Gaussian model corresponding to the each service type. The service prediction module 802 may determine a probability density value of each service type regarding the currently requested service time and/or the currently requested service location according to the mixed Gaussian model. The user's preferred service type may be predicted based on the probability density value. In some embodiments, the service prediction module 802 may determine a first probability of each service type using a Bayesian model and the probability density value of each service type, and designate a service type corresponding to a largest probability value as the user's preferred service type (i.e., predicted service type). In some embodiments, a determination may be made as to whether the largest first probability is larger than or equal to a first preset threshold. If the largest first probability is larger than or equal to the first preset threshold, the service type may be designated as the predicted service type and be output to, for example, the user terminal 130.

In some embodiments, the service prediction module 802 may obtain the frequency of each service type from the order information of the previous service requests to generate a Markov model, and input order information of an immediate previous order into the Markov model to determine a second probability of each service type. The service prediction module 802 may determine a service type with a largest second probability value. A determination may be made as to whether the largest second probability value is larger than or equal to a second preset threshold. If the largest second probability value is larger than or equal to the second preset threshold, the service type corresponding to the largest second probability may be designated as the user's preferred service type. Otherwise, the service prediction module 802 may perform clustering analysis, on the basis of the service time and/or service location, on each service type in the order information to obtain a mixed Gaussian model for each service type, and determine a probability density value of each service type at a currently requested service time and/or a currently requested service location according to a corresponding mixed Gaussian model. A service type that the user requests may be predicted according to the probability density value of each service type.

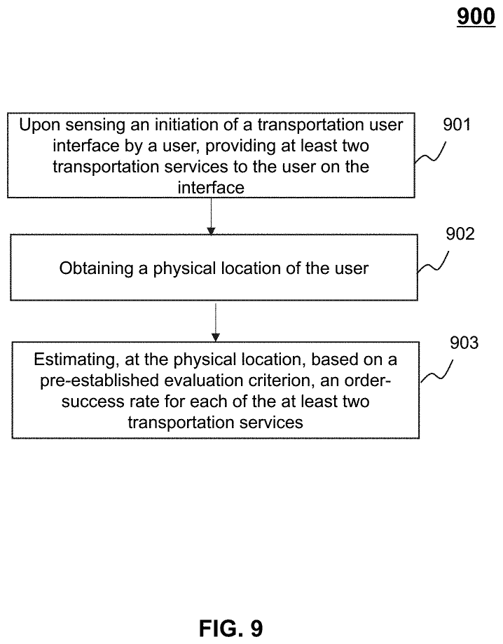

FIG. 9 is a flowchart illustrating a process 900 for determining order-success rates of transportation services according to some embodiments of the present disclosure. In some embodiments, the process 900 shown in FIG. 9 may be implemented in the transportation recommendation system 100 illustrated in FIG. 1. For example, at least a part of the process 900 may be stored in a storage device (e.g., the DISK 270 of the computing apparatus 200) as a form of instructions, and invoked and/or executed by the server 110 (e.g., the processor 220 of the computing apparatus 200). In some embodiments, a part of the process 900 may be implemented on a terminal device. The operations of the illustrated process 900 presented below are intended to be illustrative. In some embodiments, the process 900 may be accomplished with one or more additional operations not described, and/or without one or more of the operations discussed. Additionally, the order in which the operations of the process 900 as illustrated in FIG. 9 and described below is not intended to be limiting. In some embodiments, the order-success rate may be implemented by an order-success rate estimation device. The order-success rate estimation device may be an independent device, such as an application server client interacting with user client. The order-success rate estimation device may also be integrated in a device that the user's client is implemented on, for example, a smartphone, a PAD (portable android device), or other electronic mobile devices. These electronic devices may be referred to as “user terminal”. The order-success rate estimating device is in a form of an application server.

In 901, upon sensing an initiation of a transportation user interface by a user, the processing device 112 may provide at least two transportation services to the user on the interface. The at least two transportation services may be selectable for the user when he/she plans a trip.

The user's operation that opens the application program may be sensed by the processing device 112 as an initiation of a transportation user interface (also referred to as “initiation information”), which will be transmitted to the applications server. The opened application program presents various transportation services for the user to choose.

The transportation service may include transportation of any type, for example, a taxi, a private car (an express car, a chauffeured car, a ride-sharing car, a car with a designated driver), a bicycle, etc., or public transportation with fixed stations, such as a bus, a train, a subway, etc. A user may install an application program (also referred as “APP”) presenting the transportation services in a terminal (e.g., the user terminal 130). When the user wants to reserve a taxi before departure, the user may click the terminal to open the application program installed on the terminal.

In 902, a physical location of the user may be obtained.

In some embodiments, the physical location of the user may be the current geographic location of the user. The current geographic location of the user may be obtained using positioning technology. In some embodiments, before the current geographic location of the user is obtained, the processing device 112 may send a message to the terminal of the user (e.g., the user terminal 130) to confirm whether to activate the positioning function of the terminal. If the user agrees to activate the positioning function, the server 110 may obtain the user's current geographic location through the terminal of the user. For example, the current geographic location of the user is obtained by a GPS positioning device of the terminal. As another example, the current geographic location of the user may be calculated based on the location of the supply base station providing network signal for the terminal.

In some embodiments, the processing device 112 may obtain a requested location of the user instead of the current location. For example, if the user reserves a transportation service started from a certain location, the reserved location (i.e., requested location) may be obtained.

In 903, the processing device 112 may estimate, at the physical location, based on a pre-established evaluation criterion, an order-success rate for each of the at least two transportation services.

The pre-established evaluation criterion refers to one or more factors or a term of view based on which the order-success rate for each of the at least two transportation services may be determined. In some embodiments, the pre-established evaluation criterion may include but is not limited to, user portrait (e.g., the user's age, gender, whether the user account has a head portrait, career, etc.), weather condition, traffic condition, city, a ratio of drivers to passengers, workdays or weekends, the physical location is suburb area or urban area. In some embodiments, the pre-established evaluation criterion may be set by a user, according to default settings of the transportation recommendation system 100. The processing device 112 may determine a transportation service with a higher order-success rate at the user's current geographic location according to one or more of the pre-established evaluation criterion.

Merely for illustration purposes, the order-success refers that whether there is a taxi driver who accepts an order placed by a user within a preset period of time (e.g., within 1 minute) after the user requests a taxi service, such that the user and the driver may achieve a travel agreement. As another example, if the user chooses to ride a bicycle, whether there are bicycles available within a preset range of the user's physical location (e.g., within 50 meters), such that the user may reserve a bicycle.

The order-success rate refers to the possibility that service requestors and service providers are matched. Merely by ways of example, if there are 100 taxis in an area, and there are 500 users choosing taxi services in the area, the order-success rate of taxi service at this time may be 20%. In some embodiments, the pre-established evaluation criterion may vary due to different algorithms used in the order-success rate evaluation, and the order-success rate may vary accordingly. It should be noted that the embodiment above is not intended to limit the scope of the present disclosure. Those skilled in the art may adjust the pre-established evaluation criterion according to attributes or nature of transportation services and the application scenarios of the travel environment.

The order-success rate estimation method described above may be used to obtain a user's initiation information from a client application, and the client application may provide at least two types of transportation services for the user. The user's current geographic location may be obtained. An order-success rate of each transportation service at the current geographical location may be determined according to a pre-established evaluation criterion. The present disclosure enables the identification of a transportation service with a higher order-success rate on the basis of the current geographical location of the user, which facilitates analysis of the order-success rate of the user at the current service location accurately and reliably, thereby providing the user with a reliable transportation service recommendation and improving the user's travel efficiency. At the same time, it helps to make the supply-demand ratio between transportation service provider (for example, drivers) and transportation service requesters (for example, passengers) as balanced as possible, such that interests of both the service provider and the service requesters may be maximized, resource utilization is improved, and the convenience of users' travel is realized as well.

It should be noted that the above description is merely provided for the purposes of illustration, and not intended to limit the scope of the present disclosure. For persons having ordinary skills in the art, multiple variations and modifications may be made under the teachings of the present disclosure. For example, the processing device 112 may further recommend suitable transportation services to the user based on the order-success rate of each transportation service. However, those variations and modifications do not depart from the scope of the present disclosure.

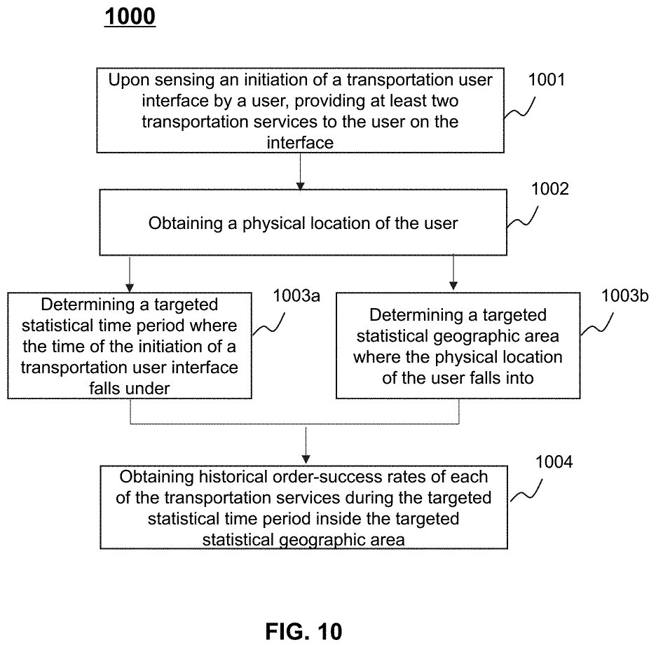

FIG. 10 is a flowchart illustrating a process 1000 for estimating order-success rates of transportation services according to some embodiments of the present disclosure. The process 1000 will be described in combination with the process 900. The order-success rate estimation method shown in the process 1000 may be implemented by a server, for example, an on-line car-hailing server, a designated driving server, etc. In some embodiments, the process 1000 shown in FIG. 10 may be implemented in the transportation recommendation system 100 illustrated in FIG. 1. For example, at least a part of the process 1000 may be stored in a storage device (e.g., the DISK 270 of the computing apparatus 200) as a form of instructions, and invoked and/or executed by the server 110 (e.g., the processor 220 of the computing apparatus 200). In some embodiments, a part of the process 1000 may be implemented on a terminal device. The operations of the illustrated process 1000 presented below are intended to be illustrative. In some embodiments, the process 1000 may be accomplished with one or more additional operations not described, and/or without one or more of the operations discussed. Additionally, the order in which the operations of the process 1000 as illustrated in FIG. 10 and described below is not intended to be limiting.

In 1001, upon sensing an initiation of a transportation user interface by a user, the processing device 112 may provide at least two transportation services to the user on the interface. The at least two transportation services may be selectable for the user when he/she plans a trip.

In 1002, a physical location of the user may be obtained. In some embodiments, the physical location may be the current geographic of the user.

A pre-established evaluation criterion used to estimating an order-success rate of each of one or more available transportation services may be obtained. In some embodiments, the pre-established evaluation criterion may include but is not limited to, user portrait (e.g., the user's age, gender, whether the user account has a head portrait, career, etc.), weather condition, traffic condition, city, a ratio of drivers to passengers, workdays or weekends, the physical location is suburb area or urban area. In some embodiments, the pre-established evaluation criterion includes a statistical time period and a statistical geographic area.

In 1003a, the processing device 112 may determine a targeted statistical time period where the time of the initiation of the transportation user interface falls under.

A statistical time period may refer to a time gap with a certain length. In some embodiments, it may be defined that each hour is a statistical time period, for example, a statistical time period from 0 o'clock to 1 o'clock, a statistical time period from 8 o'clock to 9 o'clock, etc. In some embodiments, the processing device 112 may obtain a supply-demand ratio in each statistical time period, for example, by processing a plurality of previous orders (i.e., historical orders) using an algorithm (e.g., a clustering algorithm). The processing device 112 may determine the statistical time period based on the processed previous orders.

Merely by ways of example, the statistical time periods may have different lengths. For example, during morning/evening peak hours, the statistical time periods may be set as 5:00˜5:15, 5:15˜5:30, 5:30˜5:45, . . . , etc., with a length of 15 minutes. During wee hours, the statistical time periods may be set as 1:00˜2:00, 2:00˜3:00, . . . , etc., with a length of 1 hour. It should be noted that the statistical time periods are merely for illustration purposes, not intended to limit the scope of the present disclosure. During morning peak time, most users are intended to go to work, meeting, etc., and the statistical time periods may be concentrated, for example, every 2 minutes may be set as a statistical time period.

When the user clicks the terminal device to activate the client program, the operation that the user activates the client forms the initiation information. The initiation information may be transmitted to the applications server. The application server may determine a statistical time period where the time of the initiation of the transportation user interface falls under, and the determined statistical time period may be designated as a targeted statistical time period. For example, if statistical time periods are preset as 7:55˜8:00, 8:00˜8:05, 8:05˜8:10, . . . , etc., a statistical time period 8:00˜8:05 may be determined as a targeted statistical time period when the user opens the client application at 8:02. Generally, a time difference between a time point when the user opens the client application and a time point when the application server receives the initiation information may be milliseconds or seconds, which can be ignored.

In 1003b, the processing device 112 may determine a targeted statistical geographic area where the physical location of the user falls into.

A statistical geographic area refers to a minimum geographic area including the physical location (e.g., current geographic location) of the user. The defining of the statistical geographic areas may be similar to the statistical time periods described above.

In some embodiments, a supply-demand ratio of different statistical geographic areas may be obtained by person skilled in the art according to algorithms such as clustering on a basis of a plurality of previous orders of users. The statistical geographic area may be determined according to the supply-demand ratio. Taking Beijing as an example, a larger population may live in the second annulus area, the third annulus area, or some commercial region, and an area with one or two blocks may be set as a statistical geographic area. However, a smaller population may live in the fifth annuls area, the sixth annulus area, or other suburb areas, a larger area may be set as a statistical geographic area. It should be noted that the statistical geographic areas are merely for illustration purposes, not intended to limit the scope of the present disclosure.

In some embodiments, specific methods for determining statistical geographic areas may be used in a special geographic environment. In some embodiments, multiple factors may be considered. The factors may include whether the road is a one-way street, whether a large commercial plaza has multiple entrances and exits, whether a road has a “NO PARKING” sign, etc. The statistical geographic areas may be determined in consideration of the factors. After the statistical geographic areas are determined, a targeted statistical geographic area may be identified from the statistical geographic areas by positioning the physical location of the user. The physical location may fall into the targeted statistical geographic area.

In 1004, the processing device 112 may obtain historical order-success rates of each of the transportation services during the targeted statistical time period inside the targeted statistical geographic area.

In some embodiments, a plurality of previous orders may be obtained. The processing device may classify the plurality of previous orders according to statistical time periods and statistical geographic areas. The historical order-success rate within each statistical geographic area during each statistical time period may be obtained. The historical order-success rate is determined by obtaining previous service requests and previous service supplies in the statistical geographic area during the statistical time period.

The order-success rate corresponding to each targeted statistical time period and each targeted statistical geographic area may be determined, and a mapping table among the targeted statistical time period, the targeted statistical geographic area, and the order-success rate may be made. The mapping table may be real-time updated at a preset interval, for example, every other month, every day, etc. In addition, the mapping table may have other dimensions. For example, the mapping table may be mapping table of working days, mapping table of holidays, or mapping table of weeks. For example, the order-success rate on workdays (e.g., from 8 o'clock to 9 o'clock) may be smaller than the order-success rate on holidays (e.g., from 8 o'clock to 9 o'clock). As another example, the order-success rate on Monday (e.g., from 18 o'clock to 19 o'clock) may be larger than the order-success rate on Friday (e.g., from 18 o'clock to 19 o'clock). In some embodiments, date information may be obtained. The date information refers to the date on which the application server receives the initiation information (i.e., the date of the service request). A targeted statistical date may be determined according to the date information (e.g., Monday, Tuesday, etc.). Accordingly, a historical order-success rate regarding the date (e.g., order-success rates of previous orders on Monday and Tuesday) may be determined.

The order-success rate estimation method provided in the process 1000 may include providing at least two transportation services to the user on the interface upon sensing an initiation of a transportation user interface by a user, obtaining the time of the initiation of the transportation user interface in consideration of a pre-established evaluation criterion, and determining a targeted statistical time period into which the time of the initiation of the transportation user interface falls; obtaining a physical location of the user; determining a target statistical geographic areas into which the physical location of the user falls in consideration of the pre-established evaluation criterion; obtain historical order-success rate corresponding to each transportation service within the target statistical geographic area during the targeted statistical time period and. A transportation service with a largest order-success rate may be identified and recommended to the user, thereby providing the user with a reliable selection on transportation services, improving the travelling efficiency of the user. In addition, a balance represented by a supply-demand ratio between transportation service providers (for example, drivers) and transportation service requestors (for example, passengers) may be built, such that interests of both service providers and service requestors may be maximized, resource utilization may be improved, and the travelling convenience of users may be improved as well.

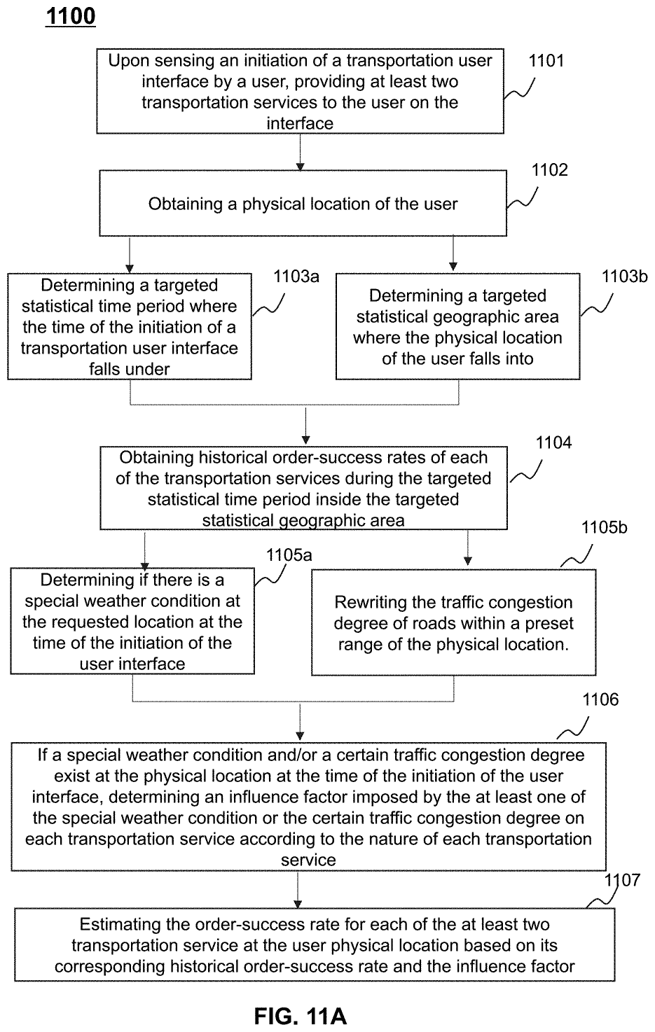

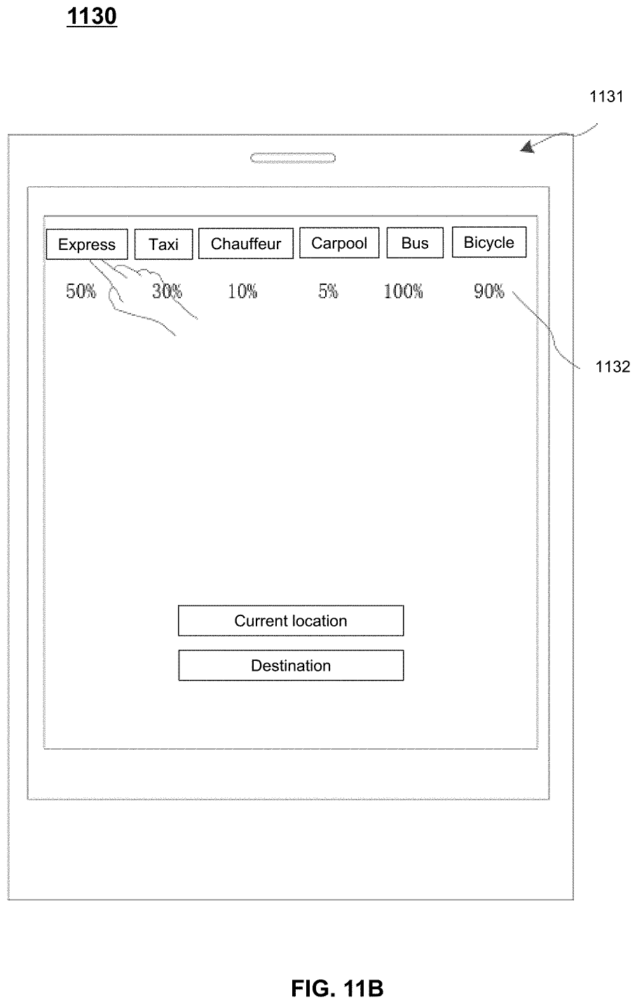

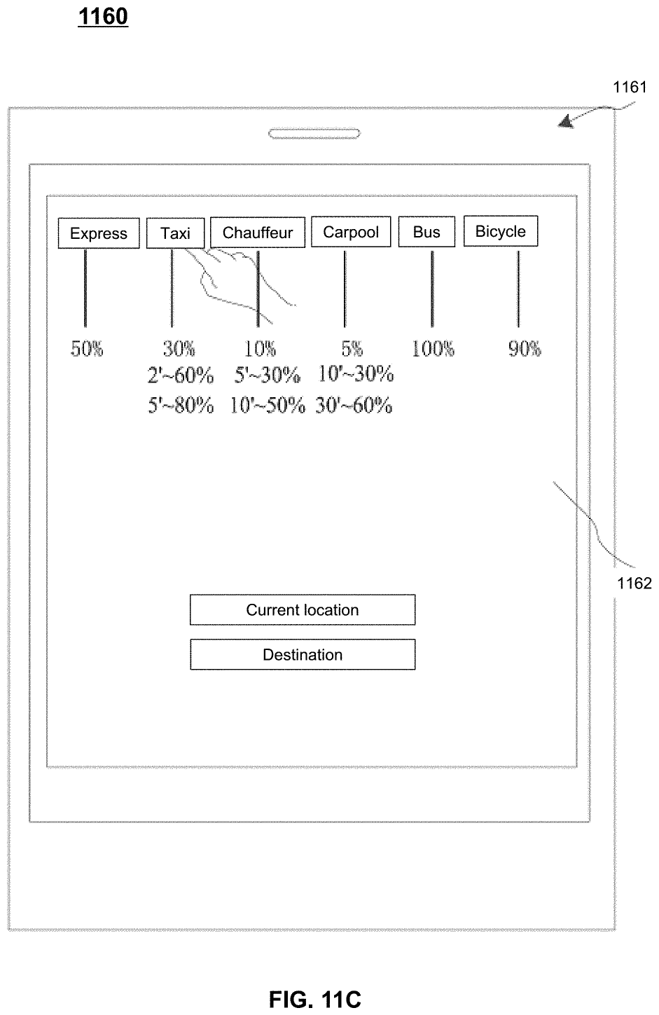

FIG. 11A is a flowchart illustrating a process 1100 for estimating order-success rates of at least two transportation services according to some embodiments of the present disclosure. The process 1100 may be described in combination with the process 1000.

In 1101, upon sensing an initiation of a transportation user interface by a user, the processing device 112 may provide at least two transportation services to the user on the interface. The at least two transportation services may be selectable for the user when he/she plans a trip.

In 1102, a physical location of the user may be obtained. In some embodiments, the physical location may be the current geographic of the user.

A pre-established evaluation criterion used to estimating an order-success rate of each of the at least two transportation services may be obtained. In some embodiments, the pre-established evaluation criterion includes a statistical time period and a statistical geographic area.

In 1103a, the processing device 112 may determine a targeted statistical time period where the time of the initiation of the transportation user interface falls under.

In 1103b, the processing device 112 may determine a targeted statistical geographic area where the physical location of the user falls into.

In 1104, the processing device 112 may obtain historical order-success rates of each of the transportation services during the targeted statistical time period inside the targeted statistical geographic area.

In some embodiments, the operations in 1101 through 1104 may be similar to or the same as the operations in 1001 through 1004.

In some embodiments, the pre-established evaluation criterion may further include, for example, weather condition, traffic condition, etc. The weather condition may include special weather condition. In some embodiments, the weather condition may be real-time weather condition or forecast weather condition. The traffic condition may include a traffic congestion degree. In some embodiments, the traffic condition may be real-time traffic condition or forecast traffic condition.

In 1105a, if the pre-established evaluation criterion includes weather condition, the processing device 112 may determine whether there is special weather condition at the physical location at the time of the initiation of the user interface.

The special weather condition refers to weather conditions that affects the historical order-success rate. For example, under weather conditions like heavy rains or blizzards, the number of transportation services such as taxi services and private cars may drop dramatically. The historical order-success rate will be much smaller due to the impact of the special weather. Therefore, it is necessary to determine whether there is special weather condition that affects the historical order-success rate according to the weather condition. If there is special weather condition, the historical order-success rate determined based on a large number of previous orders may be adjusted to provide more accurate order-success rate for the user.

In 1105b, if the pre-established evaluation criterion includes traffic condition, the processing device 112 may rewrite the traffic congestion degree of roads within a preset range of the physical location.

The traffic congestion degree relates to a road traffic flow rate determined according to real-time road condition. For example, a traffic accident occurs near the user's physical location may affect a driving speed of each vehicle in a certain range of the traffic accident. The historical order-success rate obtained will be much smaller due to the impact of traffic accident. Therefore, it is necessary to determine whether the traffic congestion degree affects the historical order-success rate according to the real-time traffic condition. If the traffic congestion degree changes, the historical order-success rate determined based on a large number of previous orders may be adjusted to provide more accurate order-success rate for the user.

In 1106, if a special weather condition and/or a certain traffic congestion degree exist at the physical location at the time of the initiation of the user interface, the processing device 112 may determine an influence factor imposed by the at least one of the special weather condition or the certain traffic congestion degree on each transportation service according to the nature of each transportation service. In some embodiments, the certain traffic congestion degree may exceed a preset traffic congestion degree threshold.

In some embodiments, pre-established evaluation criterion such as the special weather condition, the traffic congestion degree, or both may be used as an adjustment factor for adjusting the historical order-success rate. Moreover, different influence factors are set for different weather conditions and different traffic congestion degrees (for example, the higher the traffic congestion degree, the smaller the influence factor is, and the smaller the historical order-success rate will be). At the same time, the setting of the influence factor also needs to consider the nature of the transportation service. For example, in the case of congestion on the road, since a bus has a bus lane and a bicycle has a bikeway, these transportation services may be less affected by the road congestion. Therefore, for different transportation services, the influence factor may be different under a same traffic congestion degree

In 1107, the processing device 112 may estimate the order-success rate for each of the at least two transportation service at the user physical location based on its corresponding historical order-success rate and the influence factor.

After order-success rates of various transportation services are determined, the user terminal may display an order-success rate corresponding to each of the various transportation services, such that the user may select a transportation service considering order-success rates (i.e., transaction probabilities) of the various transportation services.

The user interface 1130 displaying the transportation services may be illustrated in FIG. 11B. The display screen 1131 of the terminal device 1132 displays various transportation services (express car, taxi, chauffeured cars, carpool, bus, bicycle, etc.) provided by the client application. Order-success rates of various transportation services are obtained by the operations described above (e.g., operations in the process 1100) and displayed underneath various transportation services, and the user may select a transportation service according to the order-success rates (i.e., transaction probabilities) of the various transportation services. As shown in FIG. 11B, the user selects the express service with an order-success rate of 50% and is ready to place an order requesting express service.

In some embodiments, according to different habits or preferences of the user, more selections may be provided so as to further save the user's time for decision to select a transportation service. For example, in an actual application scenario, the user wants to be faster, even if he waits for a while. Unless he needs to wait for a long time, he will choose a taxi or a chauffeured car. Then the user may be provided with order-success rates of a current order, order-success rates of an order placed after 3 minutes, order-success rates of an order placed after 5 minutes, or the like.

This specific implementation includes for those transportation services where the estimated order-success rate is smaller than the preset order-success rate threshold, the processing device 112 may obtain a historical order-success rate for each of those transportation services during a time period that is immediately subsequent to the service request time (a postponed time period). The processing device 112 may transmit the historical order-success rates of those transportation services together with their corresponding postponed time periods to match their respective transportation services on the interface. That is, if the first transportation service is an express car, and the order-success rate of the express service (for example, 30%) is less than a preset threshold (for example, 50%), then the user obtains history order-success rates of the express car during time periods that are subsequent to the current time, thereby showing the user how long it takes to request a service successfully.

The user interface 1160 displaying the transportation services and the corresponding order-success rates may be illustrated in FIG. 11C. The display screen 1161 of the user terminal 1162 displays various transportation services (the express car, taxi, chauffeured cars, ride-sharing, bus, bicycle and etc.) provided by the client application. The order-success rates of the various transportation services are displayed underneath the various transportation services. If the preset threshold is 50%, order-success rates of the transportation services may be displayed to the user (as shown in FIG. 11, a variety of situations may be showed underneath the taxi service, the chauffeur service, and carpool service. The current order-success rate of the express service is 50%, the current order-success rate of the taxis service is 30%, which will increase to 60% after 2 minutes and increase to 80% after 5 minutes). The user may select a transportation service according to the displayed order-success rates. As shown in FIG. 11C, when the user clicks on the taxi service, the probability that the user calls a taxi successfully within 2 minutes is 30%, the probability will increase to 60% after 2 minutes, and the probability will increase to 80% after 5 minutes.

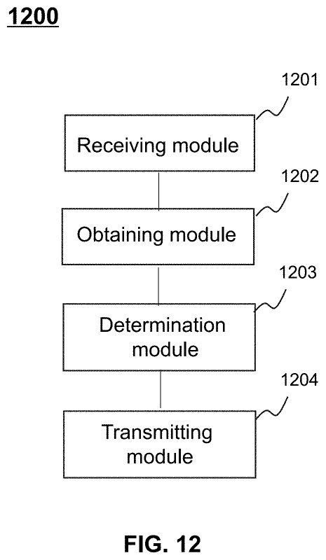

FIG. 12 is a schematic diagram of an order-success rate estimation device according to some embodiments of the present disclosure. The order-success rate estimation device 1200 may include a receiving module 1201, an obtaining module 1202, a determination module 1203, and a transmitting module 1204.

The receiving module 1201 may provide at least two transportation services to the user on the interface upon sensing an initiation of a transportation user interface by a user. The at least two transportation services may be selectable for the user when he/she plans a trip.

The obtaining module 1202 may obtain a physical location of the user.

The determination module 1203 may estimate, at the physical location, based on a pre-established evaluation criterion, an order-success rate for each of the at least two transportation services.

The order-success rate estimation device described above may be configured to obtain a user's initiation information from a client application, and the client application may provide at least two types of transportation services for the user. The user's current geographic location may be obtained. An order-success rate of each transportation service at the current geographical location may be determined according to a pre-established evaluation criterion. The present disclosure enables the identification of a transportation service with a higher order-success rate on the basis of the current geographical location of the user, which facilitates analysis of the order-success rate of the user at the current service location accurately and reliably, thereby providing the user with a reliable transportation service recommendation and improving the user's travel efficiency. At the same time, it helps to make the supply-demand ratio between transportation service provider (for example, drivers) and transportation service requesters (for example, passengers) as balanced as possible, such that interests of both the service provider and the service requesters may be maximized, resource utilization is improved, and the convenience of users' travel is realized as well.

In some embodiments, the determination module may further include a statistical time period determination sub-module. The statistical time period determination sub-module may determine a targeted statistical time period where the time of the initiation of the transportation user interface falls under.

In some embodiments, the determination module may further include a statistical geographic area determination sub-module. The statistical geographic area determination sub-module may determine a targeted statistical geographic area where the physical location of the user falls into.

In some embodiments, the determination module may further include a historical order-success rate obtaining sub-module. The historical order-success rate obtaining sub-module may obtain historical order-success rates of each of the transportation services during the targeted statistical time period inside the targeted statistical geographic area. In some embodiments, the historical order-success rate may be determined by obtaining previous service requests and previous service supplies in the statistical geographic area during the statistical time period.

In some embodiments, the determination module may further include a weather determination sub-module. The weather determination sub-module may determine whether there is special weather condition at the physical location at the time of the initiation of the user interface if the pre-established evaluation criterion includes weather condition.

In some embodiments, the determination module may further include a traffic condition determination sub-module. The traffic condition determination sub-module rewrite the traffic congestion degree of roads within a preset range of the physical location if the pre-established evaluation criterion includes traffic condition.

In some embodiments, the determination module may further include a influence factor determination sub-module. The influence factor determination sub-module may determine an influence factor imposed by the at least one of the special weather condition or the certain traffic congestion degree on each transportation service according to the nature of each transportation service if a special weather condition and/or a certain traffic congestion degree exist at the physical location at the time of the initiation of the user interface.

In some embodiments, the determination module may further include an order-success rate determination sub-module. The order-success rate determination sub-module may estimate the order-success rate for each of the at least two transportation service at the user physical location based on its corresponding historical order-success rate and the influence factor.

In some embodiments, the obtaining module 1202 may be further configured to obtain date information. The date information refers to the date on which the application server receives the initiation information (i.e., the date of the service request). Accordingly, the determination module may further include a statistical date determination sub-module. The statistical date determination sub-module may determine a targeted statistical date according to the date information (e.g., Monday, Tuesday, etc.). Accordingly, the historical order-success rate obtaining sub-module may obtain a historical order-success rate regarding the date (e.g., order-success rates of previous orders on Monday and Tuesday).

The transmitting module 1204 may be configured to transmit, to the user, order-success rates of at least two travelling services at a targeted statistical time period inside a targeted statistical geographic area.

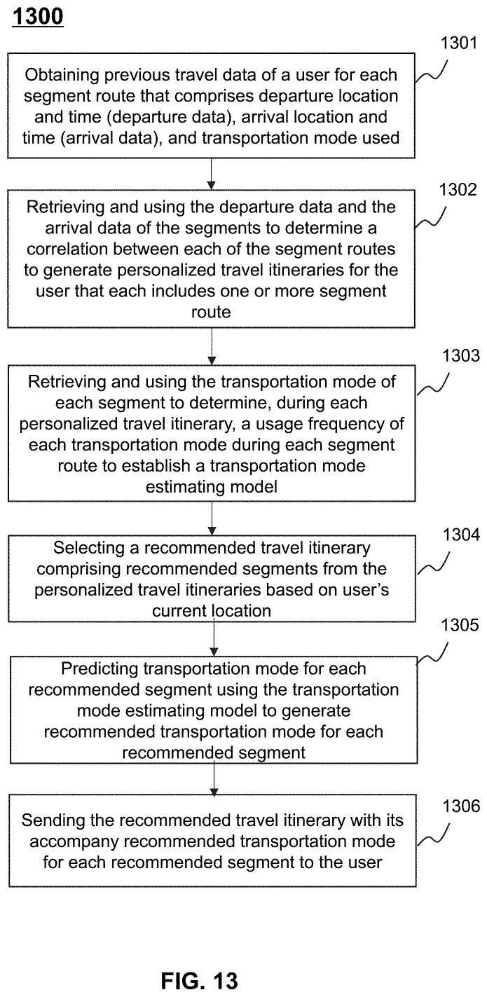

FIG. 13 is a flowchart illustrating a process 1300 for recommending a transportation mode according to some embodiments of the present disclosure. In some embodiments, the process 1300 shown in FIG. 13 may be implemented in the transportation recommendation system 100 illustrated in FIG. 1. For example, at least a part of the process 1300 may be stored in a storage device (e.g., the DISK 270 of the computing apparatus 200) as a form of instructions, and invoked and/or executed by the server 110 (e.g., the processor 220 of the computing apparatus 200). In some embodiments, a part of the process 1300 may be implemented on a terminal device. The operations of the illustrated process 1300 presented below are intended to be illustrative. In some embodiments, the process 1300 may be accomplished with one or more additional operations not described, and/or without one or more of the operations discussed. Additionally, the order in which the operations of the process 1300 as illustrated in FIG. 13 and described below is not intended to be limiting.

As shown in FIG. 13, the transportation mode recommending method may be implemented in a transportation mode recommending device. The transportation mode recommending device may be implemented by hardware and/or software. In actual applications, and the transportation mode recommending device may be may be an independent device, such as an application server client interacting with user client. The transportation mode recommending device may also be integrated in a cloud server on which a network platform providing transportation service (hereinafter referred to as “platform”) is based, and used in conjunction with a data server storing various types of databases on which a network platform providing transportation service is based. In addition, the server on which the transportation mode recommending device is based can be the data server, or a different server of a same server cluster as the data server, which is not limited. The transportation mode recommending device can also be integrated in a device supported by a client of a user interacting with a network platform that provides transportation services. The transportation mode recommending method may be realized by performing information interaction and data update with the network platform providing transportation service. The device supported by the user's client may be, for example, a smartphone, a PAD (portable android device), or other electronic mobile devices. These electronic devices may be referred to as “user terminal”. The transportation mode recommending device may be in a form of an application server.

In 1301, the processing device 112 may obtain previous travel data of a user for each segment route that comprises departure location and time (departure data), arrival location and time (arrival data), and transportation mode used.

The previous travel data refers data collected on a travel itinerary. The travel itinerary may include a plurality of segments. The previous travel data may include departure data, arrival data, and transportation mode used on each segment of the travel itinerary. The departure data may include, for example, a departure location (i.e., departure location) and a departure time of each segment of a travel itinerary. The arrival data may include, an arrival location (i.e., arrival location) and an arrival time of each segment of the travel itinerary. The previous travel data may be obtained by a network platform that provides transportation services and collects orders of the user through the network platform. The transportation mode used in each segment of the travel itinerary may be of any type, for example, a taxi, a private car (an express car, a chauffeured car, a car for carpooling, etc.), a bicycle, or public transportation with fixed stations, such as a bus, a train, a subway, etc. The user may install a applications program (APP) presenting the various traveling services in the terminal. Taking an actual application scenario as an example, the user may schedule a taxi through the platform before departure. The platform may store this travelling record of the user taking a taxi as previous travel data of the user.

In 1302, the processing device 112 may retrieve and use the departure data and the arrival data of the segments to determine a correlation between each of the segment routes to generate personalized travel itineraries for the user that each includes one or more segment route.

The correlation between the segments of a travel itinerary refers that discrete journeys of a user in a certain time period may form a personalized travel trajectory. In some embodiments, a coordinate of the arrival location of a first journey and a coordinate of the departure location of a second journey may be connected along a travel direction of the user. For example, if the user set off from location A, traverse location B, then goes to location C, and finally arrives at location D, the four geographic locations A, B, C, and D are connected sequentially to obtain a travel trajectory of the user. The departure location and the arrival location of each segment on a travel itinerary means that, for example, when the user takes a shared bicycle at location A, the platform records the location A as the departure location of a first segment on a travel itinerary; when the user rides the bicycle to location B and transfers to a subway, the platform records location B as the arrival location of the first segment on the travel itinerary, and the first segment is from A to B. The user starts the travel on a second segment of the travel itinerary by buying a ticket at location B or entering the subway station nearby. When the user arrives at location C on subway and requests an express service via the platform, the second segment from B to C may be recorded. In the second segment, the platform records location B as the departure location, and location C as the arrival location. Similarly, if the user takes an express car at location C, location C may be the departure location of a third segment on the travel itinerary. If the user arrives at location D, the platform may record location D as the arrival location of the third segment. From location A to location D, the user uses different transportation mode. Locations A, B, C, and D are not isolated geographical locations, but forms a complete travel trajectory. Therefore, each geographical location such as A, B, C, and D described above is correlated and connected to form a personalized traveling itinerary including the above three segments route (e.g., the first segment from A to B, the second segment from B to C, the third segment from C to D).

In addition, the personalized travel itinerary of the user may be determined according to the departure time of each segment and the arrival time of each segment. For example, the platform records the previous travel data of the user from A to D, however, the journey from A to C occurs in the morning, and the journey from C to D occurs in the afternoon, then the journey from A to D may not be considered as a personalized traveling itinerary of the user. Therefore, the personalized travel itinerary may need to meet a time condition. That is, the user sets off from location A to location D, location B and location C are transit stations between location A and location D. Therefore, the journey from A to C may be a personalized travel itinerary of the user, and the journey from C to D may be another personalized travel itinerary of the user. The determination of the personalized travel itinerary may be understood by those skilled person by modeling the previous travel data of the user and/or using a statistical analysis method. For example, a machine-learning algorithm or other statistical algorithms may be used.

In 1303, the processing device 112 may retrieve and use the transportation mode of each segment to determine, during each personalized travel itinerary, a usage frequency of each transportation mode during each segment route to establish a transportation mode estimating model.

The transportation mode prediction model may be used to determine a probability that the user chooses each transportation mode in each segment route on a personalized travel itinerary. The way to establish the model may include, but is not limited to, using a mathematical model to represent each of the user's personalized travel itineraries. A constructed mathematical model is used to predict most likely transportation modes to be used by the user on each segment route of a personalized travel itinerary. The transportation mode prediction model may include, but not limited to, a Markov model, a Gaussian model, a mixed Gaussian model, a Bayesian model, or the like, or a combination thereof.

In 1304, the processing device 112 may select a recommended travel itinerary comprising recommended segments from the personalized travel itineraries based on user's current location.

In some embodiments, the current location of the user can be obtained at the time when the user opens the user interface of the platform that provides transportation services. Before the current location of the user is obtained, the method may further include sending a query message to the terminal device of the user to inquiry whether to initiate a positioning device on the terminal device. If the user agrees to initiate the positioning device, the current location of the user may be obtained by the terminal device and sent to the application server of the platform. The current location may be obtained by positioning the location of the terminal device via GPS devices, or calculating the current location of the terminal device based on signals of the terminal device, or obtaining the IP address of the terminal device.

The user's current location may be obtained. After the application server analyzes the user's previous travel data, more than one personalized travel itinerary of the user may be determined. A personalized travel itinerary including the current location may be selected as a recommended travel itinerary of the user. In different situations, according to the current location of the user, the method for determining the recommended travel itinerary of the user among personalized travel itineraries may also different. For example, if the current location of the user is obtained, the recommended travel itinerary may be determined according to the personalized travel itinerary determined in 1302. It may also be possible to determine a straight-through or transfer route between the two locations more accurately according to a combination of both a destination input by the user and the current location.

Further, multiple possible personalized travel itineraries may be selected based on the current location of the user. Then a most likely recommended travel itinerary may be recommended to the user, or several possible recommended travel itineraries may be recommended to the user accompany with a frequency that each personalized traveling itinerary is chosen according to the previous travel data. The processing device 112 may receive a confirmation message from the user to select one from the several possible recommended travel itineraries so as to determine the recommended travel itinerary.

In 1305, the processing device 112 may predict transportation mode for each recommended segment using the transportation mode estimating model to generate recommended transportation mode for each recommended segment.

In 1306, the processing device 112 may send the recommended travel itinerary with its accompany recommended transportation mode for each recommended segment to the user.

In some embodiments, after the recommended travel itinerary is determined according to the current location of the user, if the recommended travel itinerary includes multiple segment routes, the transportation mode used on each recommended segment may be predicted according to the transportation mode prediction model and recommended to the user. In some embodiments, the transportation mode prediction model may be combined with road condition to predict a suitable transportation mode, thereby providing a new transportation mode prediction model combining both the preference of the user (the transportation mode prediction model) and actual travel environment so as to further improve the travel efficiency of the user and benefit the travel experience of the user.

The traveling service recommendation method provided may include obtaining previous travel data of a user for each segment route that comprises departure location and time (departure data), arrival location and time (arrival data), and transportation mode used; retrieving and using the departure data and the arrival data of the segments to determine a correlation between each of the segment routes to generate personalized travel itineraries for the user that each includes one or more segment route; retrieving and using the transportation mode of each segment to determine, during each personalized travel itinerary, a usage frequency of each transportation mode during each segment route to establish a transportation mode estimating model; selecting a recommended travel itinerary comprising recommended segments from the personalized travel itineraries based on user's current location; predicting transportation mode for each recommended segment using the transportation mode estimating model to generate recommended transportation mode for each recommended segment; and sending the recommended travel itinerary with its accompany recommended transportation mode for each recommended segment to the user.

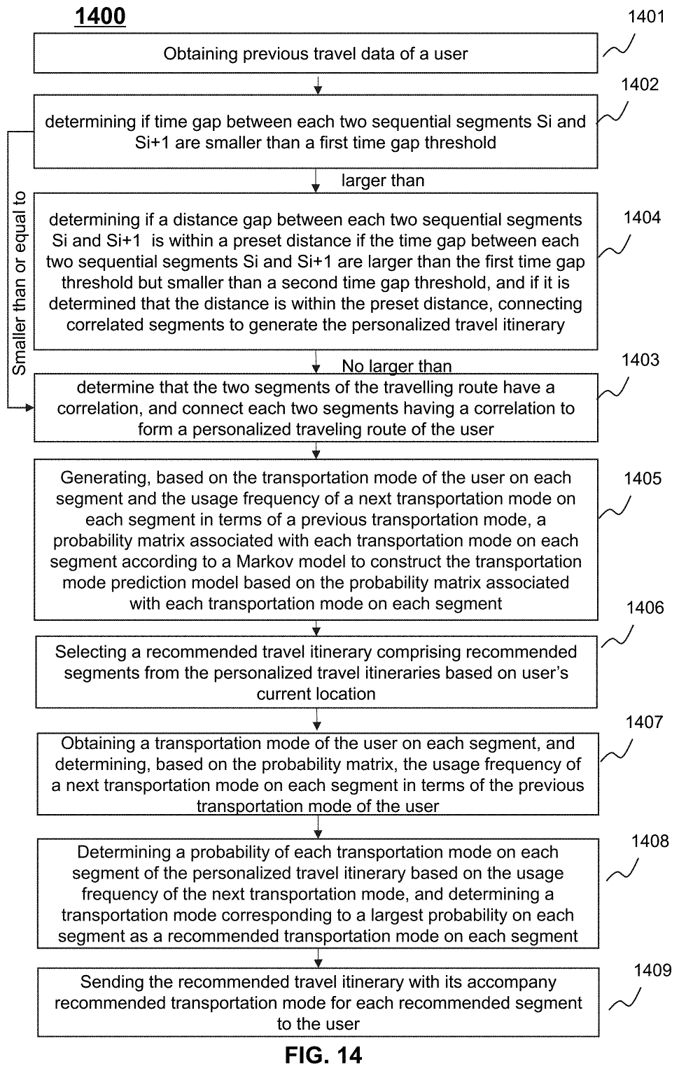

FIG. 14 is a flowchart illustrating a process 1400 for recommending a transportation mode according to some embodiments of the present disclosure. In some embodiments, the process 1400 may be described in combination with the process 1300.

In 1401, the processing device 112 may obtain previous travel data of a user for each segment route that comprises departure location and time (departure data), arrival location and time (arrival data), and transportation mode used.

In 1402, the processing device 112 may determine if time gap between each two sequential segments Sᵢ and Sᵢ₊₁ are smaller than a first time gap threshold.

As used herein, the time gap refers to a time period between an arrival time of a user on a segment and a departure time of the user on a sequential segment. If the time gap between each two sequential segments Sᵢ and Sᵢ₊₁ is smaller than or equal to a first time gap threshold, the process may proceed to 1403. If the time gap between each two sequential segments Sᵢ and Sᵢ₊₁ is larger than the first time gap threshold, the process may proceed to 1404.

In some embodiments, if the arrival time of a first segment is prior to the departure time of a second segment, the relationship between the first segment of travel and the second segment of travel may be two segments of a travel itinerary. The time gap between the arrival time of the first segment and the departure time of the second segment defines a time length between the end of the first segment and the beginning of the second segment. For example, the user takes a shared bicycle at location A, transfers to a subway after he/she arrives at location B. The user takes the subway to location C, then requests an express car to location D. If the time taking the shared bicycle at location B is t₁ (the arrival time of the first segment), the time entering the subway station at location B is t₂ (the departure time of the second segment), t₂-t₁ may represent the time gap between the arrival time of the first segment and the departure time of the second segment.

The first time gap threshold may be a threshold value that is consistent with general travel rules of the user based on a large amount of previous travel data. For example, if the user walks from a location where the shared bicycle is parked to the subway station, it may take 3 minutes. If the first time gap threshold is 10 minutes, location B may be considered as a transfer station, and the journey from A to B, and B to C may be determined as personalized traveling itinerary of the user.

In 1403, the processing device 112 may determine that the two segments of the travelling route have a correlation, and connect each two segments having a correlation to form a personalized traveling itinerary of the user.

In some embodiments, segments having correlations may be identified from 1402, and connected to each other, thereby forming a personalized traveling itinerary of the user.

In 1404, the processing device 112 may determining if a distance gap between each two sequential segments Sᵢ and Sᵢ₊₁ is within a preset distance if the time gap between each two sequential segments Sᵢ and Sᵢ₊₁ are larger than the first time gap threshold but smaller than a second time gap threshold, and if it is determined that the distance is within the preset distance, connecting correlated segments to generate the personalized travel itinerary.

If only the first time gap threshold is used to determine whether the two segments have a correlation, a large number of personalized travel itinerary of the user may be missed in many actual applications. Therefore, it is necessary to determine a personalized travel itinerary considering a geographical range threshold. For example, a user takes a subway at location A to location B, and walks to location C, then calls an express car from location C to location D. wherein, location A is the working place of the user, and location D is the user's home. It may be obvious that the journey from A to D is a personalized traveling itinerary of the user. However, since the time that the user walks from location B to location C is longer than the first time gap threshold (for example, 10 minutes), the platform may not determine the journey from A to B and the journey from C to D have a correlation.

In this case, a preset distance threshold may be used to determine whether the distance gap between location B and location C exceeds a preset distance threshold (e.g., 1 kilometer). The preset distance threshold may be a distance determined according to previous travel data. If the distance gap does not exceed the preset distance threshold, it may be considered that the user walks to location C from location B, and a personalized traveling itinerary of the user may be formed. In addition, for a user transfers at location B for some reasons, for example, to buy a bottle of water in a supermarket, etc., the time gap between the arrival time of the first segment and the departure time of the second segment may exceed the first time threshold. However, it may be determined that the user is close to location B, thereby determining that the journey from A to B and the journey from B to C have a correlation according to the preset distance threshold. Further, other methods or techniques may be used to determine whether two sequential segments have a correlation. For example, data measured by an acceleration sensor of the user terminal or a walking detection sensor may be acquired to determine whether the user walks from B to C.

In some embodiments, segments with time gaps larger than the first time gap threshold may be considered, in combination with the preset distance threshold. Therefore, it is needed to define a time gap greater than the first time gap threshold but smaller than or equal to the second time gap threshold (for example, half an hour, for a short stay at a place, or buy a bottle of water in a supermarket). In addition, in a case that a user stays at a certain place for a long time, then starts another journey, it is generally not considered to be a coherent travel itinerary. For example, in the morning, the user arrives at location B from location A, then sets off for location C, where location A is the user's home, and location C is the user's working place, location B is a transfer station. In the afternoon, the user arrives at location D from location C, then goes back to location A, which means that the user goes back home from working place on a different route. In this case, the journey from A to B to C to D, then from D to A will not be considered as a personalized traveling itinerary of the user. Instead, the journey from A to C is a personalized traveling itinerary of the user, the journey from C to A is another personalized travel itinerary of the user.

In 1405, the processing device 112 may generate, based on the transportation mode of the user on each segment and the usage frequency of a next transportation mode on each segment in terms of a previous transportation mode, a probability matrix associated with each transportation mode on each segment according to a Markov model to construct the transportation mode prediction model based on the probability matrix associated with each transportation mode on each segment.

In 1406, the processing device 112 may select a recommended travel itinerary comprising recommended segments from the personalized travel itineraries based on user's current location.

In 1407, the processing device 112 may obtain a transportation mode of the user on each segment, and determining, based on the probability matrix, the usage frequency of a next transportation mode on each segment in terms of the previous transportation mode of the user.

In 1408, the processing device 112 may a probability of each transportation mode on each segment of the personalized travel itinerary based on the usage frequency of the next transportation mode, and determining a transportation mode corresponding to a largest probability on each segment as a recommended transportation mode on each segment.

In 1409, the processing device 112 may send the recommended travel itinerary with its accompany recommended transportation mode for each recommended segment to the user.

In 1405 through 1409, the Markov model follows the Markov principle and is a statistical model that can determine the regularity of a sequence of states for each state sequence through which each state depends on a finite number of states. For the process of predicting the type of the vehicle used in each of the personalized travel itineraries, the user's historical traveling route can be obtained through the foregoing statistical determination of the user's previous travel data; Then, the frequency of a next transportation mode may be determined based on the transportation mode used in a previous travel on each personalized traveling itinerary. That is, in a personalized traveling itinerary, after the last travel uses a vehicle, the next trip uses the number distribution of various vehicles. This infers the type of vehicle that the user will use in the next trip. In order to simplify the operation, for the first-order Markov model, it is assumed that the record of the vehicle used by the user in a section of a personalized traveling itinerary is shown in Table 3.

TABLE 3

| Time | Vehicle |
|---|---|
| 2017 May 30 18:36 | Taxi |
| 2017 Jun. 2 17:58 | Taxi |
| 2017 Jun. 12 12:04 | Taxi |
| 2017 Jun. 20 20:07 | Express |
| 2017 Jun. 27 9:43 | Taxi |
| 2017 Jun. 28 13:06 | Taxi |
| 2017 Jun. 28 14:56 | Taxi |
| 2017 Jun. 28 17:40 | Taxi |
| 2017 Jun. 29 9:10 | Taxi |
| 2017 Jun. 29 11:16 | Taxi |
| 2017 Jun. 29 16:44 | Taxi |
| 2017 Jul. 3 10:26 | Taxi |
| 2017 Jul. 4 18:58 | Taxi |
| 2017 Jul. 4 22:18 | Taxi |
| 2017 Jul. 6 10:01 | Taxi |
| 2017 Jul. 7 15:06 | Taxi |
| 2017 Jul. 7 19:27 | Taxi |
| 2017 Jul. 11 9:30 | Taxi |
| 2017 Jul. 13 11:36 | Express |
| 2017 Jul. 15 15:25 | Taxi |
| 2017 Jul. 17 9:00 | Taxi |
| 2017 Jul. 18 11:42 | Taxi |
| 2017 Jul. 18 20:58 | Taxi |

According to operations in 1405, based on the Markov model, it can be derived probability matrix of Table 4,

TABLE 4

| | Taxi Next Time | Express Next Time |
|---|---|---|
| Taxi Prior Time | 18 | 2 |
| Express Prior Time | 2 | 0 |

It can be seen from the probability matrix of Table 4 that when the transportation mode used in the travel is notified to the user, the skip matrix of Table 4 can be used to predict which transportation mode to be used in the travel next time. The conditional probability obtained by statistics is as follows:

P(Y=A|X=A)=0.9,

P(Y=B|X=A)=0.1,

P(Y=A|X=B)=1,

P(Y=B|X=B)=0,

where X represents the transportation mode used last time, Y represents the transportation mode used next time, A indicates that the transportation mode is a taxi, and B indicates that the transportation mode is an express car.

Suppose that the user's immediately used transportation mode is express B in a segment, through the Markov matrix, it may be obtained that the probability of using the express B in the segment of the next time is 0, and the probability of using the taxi A is 1, the platform will recommend the taxi to select the taxi A solution for the user. The above is only described by taking a Markov matrix of a section of a personalized traveling itinerary as an example, and establishing different Markov models according to different personalized traveling itineraries, and according to the frequency of multi-segment travels included in each personalized traveling itinerary, the Markov model of different dimensions is established, thus determining the transportation mode that a user most probably takes in each segment route, such as location A to location B, location B to location C, location C to location D, and recommending to the user.

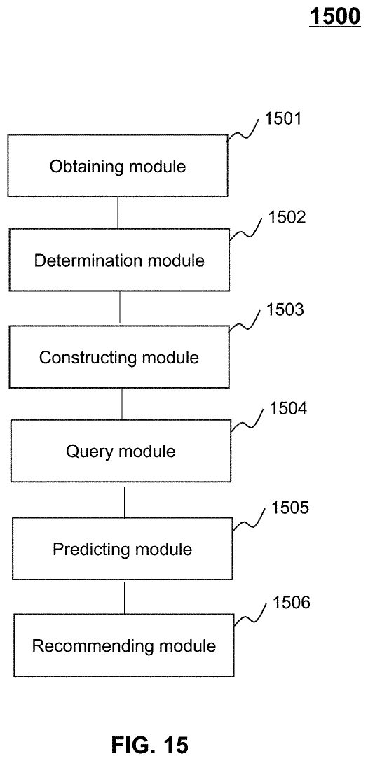

FIG. 15 is a schematic diagram of a transportation mode recommending device according to some embodiments of the present disclosure. The transportation mode recommending device 1500 may include an obtainting module 1501, a determination module 1502, a constructing module 1503, a query module 1504, a predicting module 1505, and a recommending module 1506.

The obtaining module 1501 may obtain previous travel data of a user for each segment route that comprises departure location and time (departure data), arrival location and time (arrival data), and transportation mode used.

The determination module 1502 may retrieve and use the departure data and the arrival data of the segments to determine a correlation between each of the segment routes to generate personalized travel itineraries for the user that each includes one or more segment route.

The constructing module 1503 may retrieve and use the transportation mode of each segment to determine, during each personalized travel itinerary, a usage frequency of each transportation mode during each segment route to establish a transportation mode estimating model.

The query module 1504 may select a recommended travel itinerary comprising recommended segments from the personalized travel itineraries based on user's current location.

The predicting module 1505 may predict transportation mode for each recommended segment using the transportation mode estimating model to generate recommended transportation mode for each recommended segment.

The recommending module 1506 may send the recommended travel itinerary with its accompany recommended transportation mode for each recommended segment to the user.

The transportation mode recommending device disclosed in the present disclosure may obtain previous travel data of a user for each segment route that comprises departure location and time (departure data), arrival location and time (arrival data), and transportation mode used; retrieve and use the departure data and the arrival data of the segments to determine a correlation between each of the segment routes to generate personalized travel itineraries for the user that each includes one or more segment route; retrieve and use the transportation mode of each segment to determine, during each personalized travel itinerary, a usage frequency of each transportation mode during each segment route to establish a transportation mode estimating model; select a recommended travel itinerary comprising recommended segments from the personalized travel itineraries based on user's current location; predict transportation mode for each recommended segment using the transportation mode estimating model to generate recommended transportation mode for each recommended segment; and send the recommended travel itinerary with its accompany recommended transportation mode for each recommended segment to the user.

In some embodiments, the determination module 1502 may further include a first determination sub-module. The first determination sub-module may determine time gap between each two sequential segments Sᵢ and Sᵢ₊₁ based on the arrival time of Sᵢ and the departure time of Sᵢ₊₁. If the time gap is smaller than or equal to a first time gap threshold, the first determination sub-module may generate a correlation between the two sequential segments, and connect correlated segments to generate the personalized travel itinerary.

In some embodiments, the determination module 1502 may further include a second determination sub-module. The second determination sub-module may determine a distance gap between each two sequential segments Sᵢ and Sᵢ₊₁ based on the arrival location of Sᵢ and the departure location of Sᵢ₊₁ if the time gap is larger than the first time gap threshold but smaller than or equal to a second time gap threshold. If the distance gap is smaller than or equal to a first distance gap threshold, The second determination sub-module may generate a correlation between the two sequential segments; and connect correlated segments to generate the personalized travel itinerary.

In some embodiments, the constructing module 1503 may generate, based on the transportation mode of the user on each segment and the usage frequency of a next transportation mode on each segment in terms of a previous transportation mode, a probability matrix associated with each transportation mode on each segment according to a Markov model, and construct the transportation mode prediction model based on the probability matrix associated with each transportation mode on each segment.

In some embodiments, the predicting module 1505 may further include an obtaining sub-module, a determination sub-module, a calculating sub-module, and a selecting sub-module.

The obtaining sub-module may obtain a previous transportation mode of the user on each segment;

The determination sub-module may determine, based on the probability matrix, the usage frequency of a next transportation mode on each segment in terms of the previous transportation mode of the user;

The calculating sub-module may determine a probability of each transportation mode on each segment of the personalized travel itinerary based on the usage frequency of the next transportation mode; and

The selecting sub-module may determine a transportation mode corresponding to a largest probability on each segment as a recommended transportation mode on each segment.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1-15. (canceled)

16. A method implemented on a device having at least one processor and at least one computer-readable storage medium for recommending a transportation mode on a travel itinerary to a user, wherein the travel itinerary comprises a plurality of segments, each having a segment route, the method comprising:
obtaining and storing, in the storage medium, the user's previous travel data for each segment route that comprises departure location and time (departure data), arrival location and time (arrival data), and transportation mode used;
retrieving and using, by the processor, the departure data and the arrival data of the segments to determine a correlation between each of the segment routes to generate personalized travel itineraries for the user that each includes one or more segment route;
retrieving and using, by the processor, the transportation mode of each segment to determine, during each personalized travel itinerary, a usage frequency of each transportation mode during each segment route to establish a transportation mode estimating model;
selecting a recommended travel itinerary comprising recommended segments from the personalized travel itineraries based on user's current location; and
predicting transportation mode for each recommended segment using the transportation mode estimating model to generate recommended transportation mode for each recommended segment.

17. The method of claim 16, further comprising sending the recommended travel itinerary with its accompany recommended transportation mode for each recommended segment to the user.

18. The method of claim 16, wherein the personalized travel itinerary is generated by:
determining time gap between each two sequential segments Sᵢ and Sᵢ₊₁ based on the arrival time of Sᵢ and the departure time of Sᵢ₊₁;
if the time gap is smaller than or equal to a first time gap threshold, generating a correlation between the two sequential segments; and
connecting correlated segments to generate the personalized travel itinerary.

19. The method of claim 18, further comprising:
if the time gap is larger than the first time gap threshold but smaller than or equal to a second time gap threshold,
determining a distance gap between each two sequential segments Sᵢ and Sᵢ₊₁ based on the arrival location of Sᵢ and the departure location of Sᵢ₊₁;
if the distance gap is smaller than or equal to a first distance gap threshold, generating a correlation between the two sequential segments; and
connecting correlated segments to generate the personalized travel itinerary.

20. The method of claim 16, further including:
obtaining a road condition on each segment; and
optimizing the transportation mode estimating model based on the road condition on each segment.

21-35. (canceled)

36. A system for recommending a transportation mode on a travel itinerary to a user, wherein the travel itinerary comprises a plurality of segments, each having a segment route, comprising:
at least one storage medium including a set of instructions; and
at least one processor configured to communicate with the at least one storage medium, wherein when executing the set of instructions, the at least one processor is directed to:
obtain and store, in the storage medium, the user's previous travel data for each segment route that comprises departure location and time (departure data), arrival location and time (arrival data), and transportation mode used;
retrieve and use, by the processor, the departure data and the arrival data of the segments to determine a correlation between each of the segment routes to generate personalized travel itineraries for the user that each includes one or more segment route;
retrieve and use, by the processor, the transportation mode of each segment to determine, during each personalized travel itinerary, a usage frequency of each transportation mode during each segment route to establish a transportation mode estimating model;
select a recommended travel itinerary comprising recommended segments from the personalized travel itineraries based on user's current location; and
predict transportation mode for each recommended segment using the transportation mode estimating model to generate recommended transportation mode for each recommended segment.

37. The system of claim 36, the at least one processor is further directed to send the recommended travel itinerary with its accompany recommended transportation mode for each recommended segment to the user.

38. The system of claim 36, wherein the personalized travel itinerary is generated by:
determining time gap between each two sequential segments Sᵢ and Sᵢ₊₁ based on the arrival time of Sᵢ and the departure time of Sᵢ₊₁;
if the time gap is smaller than or equal to a first time gap threshold, generating a correlation between the two sequential segments; and
connecting correlated segments to generate the personalized travel itinerary.

39. The system of claim 38, further comprising:
if the time gap is larger than the first time gap threshold but smaller than or equal to a second time gap threshold,
determining a distance gap between each two sequential segments Sᵢ and Sᵢ₊₁ based on the arrival location of Sᵢ and the departure location of Sᵢ₊₁;
if the distance gap is smaller than or equal to a first distance gap threshold, generating a correlation between the two sequential segments; and
connecting correlated segments to generate the personalized travel itinerary.

40. The system of claim 36, the at least one processor is further directed to:
obtain a road condition on each segment; and
optimize the transportation mode estimating model based on the road condition on each segment.

41-43. (canceled)

44. The method of claim 19, further including:
generating, based on the transportation mode of the user on each segment and the usage frequency of a next transportation mode on each segment in terms of a previous transportation mode, a probability matrix associated with each transportation mode on each segment according to a Markov model to construct the transportation mode prediction model based on the probability matrix associated with each transportation mode on each segment.

45. The method of claim 44, further including:
obtaining a transportation mode of the user on each segment, and determining, based on the probability matrix, the usage frequency of a next transportation mode on each segment in terms of the previous transportation mode of the user.

46. The method of claim 45, further including:
determining a probability of each transportation mode on each segment of the personalized travel itinerary based on the usage frequency of the next transportation mode, and
determining a transportation mode corresponding to a largest probability on each segment as a recommended transportation mode on each segment.

47. The system of claim 39, the at least one processor is further directed to:
generate, based on the transportation mode of the user on each segment and the usage frequency of a next transportation mode on each segment in terms of a previous transportation mode, a probability matrix associated with each transportation mode on each segment according to a Markov model to construct the transportation mode prediction model based on the probability matrix associated with each transportation mode on each segment.

48. The system of claim 47, the at least one processor is further directed to:
obtain a transportation mode of the user on each segment, and determining, based on the probability matrix, the usage frequency of a next transportation mode on each segment in terms of the previous transportation mode of the user.

49. The system of claim 48, the at least one processor is further directed to:
determine a probability of each transportation mode on each segment of the personalized travel itinerary based on the usage frequency of the next transportation mode, and
determine a transportation mode corresponding to a largest probability on each segment as a recommended transportation mode on each segment.
